(19) United States
(12) Patent Application Publication
(10) Pub. No.: US 2008/0280659 A1
(43) Pub. Date: Nov. 13, 2008

(54) SLIDING APPARATUS OF SLIDING TYPE PORTABLE TERMINAL

(75) Inventors: Seung-Taek OH, Seoul (KR); Woo-Seok CHIN, Suwon-si (KR); Shin-Chul KANG, Seoul (KR); Young-Ki KIM, Yongin-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/115,783

(22) Filed: May 6, 2008

(30) Foreign Application Priority Data
May 8, 2007 (KR) 10-2007-0044683

(51) Int. Cl. H04M 99/00

(52) U.S. Cl. 455/575.4

(57) ABSTRACT

A sliding apparatus of a sliding type portable terminal allows a sliding housing of the sliding type portable terminal to slide in two directions. The sliding apparatus of a sliding type portable terminal includes a main housing including a fixing member and a sliding housing slidably coupled with the main housing. The sliding housing includes a guide part that is engages with the fixing member to guide the sliding housing along a curved path on the main housing in a left direction and a right direction about a central axis of the fixing member.

### CROSS REFERENCE TO RELATED APPLICATION

This application claims priority from and the benefit of Korean Patent Application No. 10-2007-0044683, filed on May 8, 2007, which is hereby incorporated by reference for all purposes as if fully set forth herein.

### BACKGROUND OF THE INVENTION

1. Field of the Invention

The present invention relates to a sliding apparatus of a sliding type portable terminal, in which a sliding housing of the sliding type portable terminal may slide in two curved directions, which may enable a user to use each mode of the portable terminal in a different manner and may achieve diversity in portable terminals.

2. Discussion of the Background

In general, “portable communication apparatus” refers to an electronic apparatus that a user can carry to perform wireless communication with a desired partner. Such portable communication apparatuses may be classified according to their appearance as bar-type portable communication apparatuses, flip-type portable communication apparatuses, and folder-type portable communication apparatuses. A bar-type communication apparatus has a single housing shaped like a bar. A flip-type communication apparatus has a flip rotatably coupled to a bar-shaped housing by a hinge device. A folder-type communication apparatus has a folder connected to a single bar-shaped housing by a hinge device in such a manner that the folder can be rotated to fold onto or unfold from the housing.

In addition, portable communication apparatuses may be classified as rotation-type communication apparatuses and sliding-type communication apparatuses according to the manner in which the communication apparatus is opened and closed. In a rotation-type communication apparatus, two housings are coupled to each other such that one of the housings rotates to be opened or closed relative to the other while the two housings face each other. In a sliding-type communication apparatus, two housings are coupled to each other such that one housing slides along a longitudinal direction to be opened or closed relative to the other housing.

Herein, a conventional sliding type portable terminal includes a main body and a sliding body capable of linearly sliding a predetermined distance on the main body. A guide means is included in the main body and the sliding body to guide the sliding body on the main body, and at least one coil spring or at least one push rod is included between the sliding body and the main body to provide an elastic force allowing the sliding body to linearly slide upward and downward.

Korean patent application number 10-2002-0071911 and corresponding U.S. Pat. No. 6,822,871, which were filed by the present applicant and are hereby fully incorporated by reference, disclose a portable terminal having a pair of housings slidably coupled with each other and a sliding apparatus thereof. In the disclosed patent, a portable terminal has a structure in which a second housing, such as a keypad, is opened and closed when a first housing slides. The first housing includes a spring module coupled therewith, and the second housing includes a rail-shaped sliding guide coupled therewith so that the housings are slidably coupled.

However, the sliding apparatus of a conventional sliding type portable terminal has a structure in which a sliding body linearly slides along one direction respective to the main body. Therefore, when the portable terminal is converted to various mode functions while being used, the sliding body always slides along a single direction, which may reduce use efficiency of the portable terminal.

Also, a main plate may be included in the main body, a sliding plate may be included in a sliding body, and a torsion spring or a push rod to allow the sliding body to slide may be included between respective the plates. Therefore, when the sliding body slides on the main body, a guide means is exposed on a rear surface of the portable terminal, and the outer circumference of the sliding body may change or deform the guide means. Furthermore, the average life span of a product may decrease due exposure of the guide means to the outer circumference of the sliding body, and it may be difficult to secure an aesthetic appearance thereof.

### SUMMARY OF THE INVENTION

The present invention provides a sliding apparatus of a sliding type portable terminal, in which a sliding housing of the portable terminal can slide along a curved direction according to use modes of the portable terminal, which may improve efficiency in using the portable terminal.

The present invention also provides a sliding apparatus of a sliding type portable terminal that may prevent a guide means, which allows the sliding housing of the portable terminal to slide along a curved line, from being exposed so that change and deformation of the guide means of the sliding apparatus of the portable terminal due to an outer circumference of a sliding body may be prevented, thereby extending the life span of the guide means.

Additional features of the invention will be set forth in the description which follows, and in part will be apparent from the description, or may be learned by practice of the invention.

The present invention discloses a sliding apparatus of a sliding type portable terminal including a main housing including a fixing member, and a sliding housing slidably coupled with the main housing, the sliding housing including a guide part that engages with the fixing member to guide the sliding housing along a curved path on the main housing in a left direction and a right direction about a central axis of the fixing member.

The present invention also discloses a sliding apparatus of a sliding type portable terminal including a main housing including a first fixing member and a second guide part, and a sliding housing slidably coupled with the main housing, the sliding housing including a second fixing member and a first guide part. The first guide part is engaged with the first fixing member to guide the sliding housing along a curved path on the main housing in a left direction and a right direction about a central axis of the first fixing member, and the second guide part is engaged with the second fixing member to guide the sliding housing member along a curved path on the main housing in the left direction and the right direction about a central axis of the second fixing member.

The present invention also discloses a sliding apparatus of a sliding type portable terminal including a main housing and including a fixing member, a sliding housing slidably coupled with the main housing, the sliding housing including a guide member, and a force supplying unit to supply a force to slide sliding housing on the main housing. The guide member engages with the fixing member to guide the sliding housing along a curved path on the main housing in a left direction and a right direction about a central axis of the fixing member.

The present invention also discloses a sliding apparatus of a sliding type portable terminal including a main housing including a first fixing member and a second guide member, a sliding housing slidably coupled with the main housing, the sliding housing including a second fixing member and a first guide member. The first guide member is engaged with the first fixing member to guide the sliding housing along a curved path on the main housing in a left direction and a right direction about a central axis of the first fixing member, and the second guide member is engaged with the second fixing member to guide the sliding housing member along a curved path on the main housing in the left direction and the right direction about a central axis of the second fixing member.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view showing a sliding apparatus of a sliding type portable terminal according to the first exemplary embodiment of the present invention.

FIG. 2 is an exploded perspective view showing a guide part included at a rear surface of a sliding housing of a sliding apparatus of a sliding type portable terminal according to the first exemplary embodiment of the present invention.

FIG. 3 is a plan view showing a fixing member being engaged with at a stopper groove of a sliding apparatus of a sliding type portable terminal according to the first exemplary embodiment of the present invention.

FIG. 4 is a plan view showing a sliding housing of a sliding apparatus of a sliding type portable terminal according to the first exemplary embodiment of the present invention sliding along a first direction of a main housing.

FIG. 5 is a plan view showing a sliding housing of a sliding apparatus of a sliding type portable terminal according to the first exemplary embodiment of the present invention sliding along the second direction of a main housing to face the main housing and be parallel to an upper side of the main housing.

FIG. 6 is a plan view showing the operation of a sliding housing of a sliding apparatus of a sliding type portable terminal according to the first exemplary embodiment of the present invention sliding along a second direction of the main housing.

FIG. 7 is a plan view showing a state of a sliding housing of a sliding apparatus of a sliding type portable terminal according to the first exemplary embodiment of the present invention sliding along the second direction of a main housing to face the main housing and be parallel to an upper side of the main housing.

FIG. 8 is an exploded perspective view showing a sliding type portable terminal according to the second exemplary embodiment of the present invention.

FIG. 9 is a plan view showing a rear surface of a sliding housing and a front surface of a main housing of a sliding type portable terminal according to the second exemplary embodiment of the present invention, in which the first guide part is mounted on the rear surface of the sliding housing and the second guide part is mounted on the front surface of the main housing.

FIG. 10 is a plan view showing a sliding housing and a main housing of a sliding apparatus of a sliding type portable terminal according to the second exemplary embodiment of the present invention being assembled with each other.

FIG. 11 is a plan view showing the operation of a sliding housing of a sliding apparatus of a sliding type portable terminal according to the second exemplary embodiment of the present invention sliding along the first direction of a main housing.

FIG. 12 is a plan view showing a sliding housing of a sliding apparatus of a sliding type portable terminal according to the second exemplary embodiment of the present invention sliding along the first direction of a main housing to face the main housing and be parallel to an upper side of the main housing.

FIG. 13 is a plan view showing a sliding housing of a sliding apparatus of a sliding type portable terminal according to the second exemplary embodiment of the present invention sliding along the second direction of a main housing.

FIG. 14 is a plan view showing a sliding housing of a sliding apparatus of a sliding type portable terminal according to the second exemplary embodiment of the present invention sliding along the second direction of a main housing to face the main housing and be parallel to an upper side of the main housing.

FIG. 15 is an exploded perspective view showing a sliding apparatus of a sliding type portable terminal according to the third exemplary embodiment of the present invention.

FIG. 16 is an exploded perspective view of part A of FIG. 8.

FIG. 17 is a plan view showing a rear surface of a sliding housing, on which a guide member is mounted, and a front surface of a main housing, on which a fixing member having a force supplying unit is mounted, of a sliding apparatus of a sliding type portable terminal according to the third exemplary embodiment of the present invention.

FIG. 18 is a plan view showing a state of a sliding housing and a main housing of a sliding apparatus of a sliding type portable terminal according to the third exemplary embodiment of the present invention being assembled with each other.

FIG. 19 is a plan view showing the operation of a sliding housing of a sliding apparatus of a sliding type portable terminal according to the third exemplary embodiment of the present invention sliding along the first direction of a main housing.

FIG. 20 is a plan view showing a state of a sliding housing of a sliding apparatus of a sliding type portable terminal according to the third exemplary embodiment of the present invention sliding along the first direction of a main housing to face the main housing and be parallel to an upper side of the main housing.

FIG. 21 is a plan view showing a sliding housing of a sliding apparatus of a sliding type portable terminal according to the third exemplary embodiment of the present invention sliding along the second direction of a main housing.

FIG. 22 is a plan view showing a sliding housing of a sliding apparatus of a sliding type portable terminal according to the third exemplary embodiment of the present invention sliding along the second direction of a main housing to face the main housing and be parallel to an upper side of the main housing.

FIG. 23 is a plan view showing another force supplying unit of a sliding type portable terminal according to the third exemplary embodiment of the present invention.

FIG. 24 is a plan view showing another force supplying unit of a sliding type portable terminal according to the third exemplary embodiment of the present invention.

FIG. 25 is an exploded perspective view showing a sliding apparatus of a sliding type portable terminal according to the fourth exemplary embodiment of the present invention.

FIG. 26 is a perspective view showing a sliding housing having the first guide member is mounted thereon, and a main housing having the second guide member mounted thereon of a sliding apparatus of a sliding type portable terminal according to the fourth exemplary embodiment of the present invention.

FIG. 27 is a plan view showing a rear surface of a sliding housing having the first guide member mounted thereon, and a front surface of a main housing having the second guide member mounted thereon of a sliding apparatus of a sliding type portable terminal according to the fourth exemplary embodiment of the present invention.

FIG. 28 is a plan view showing a sliding housing and a main housing of a sliding apparatus of a sliding type portable terminal according to the fourth exemplary embodiment of the present invention being assembled with each other.

FIG. 29 is a plan view showing a sliding housing of a sliding apparatus of a sliding type portable terminal according to the fourth exemplary embodiment of the present invention sliding along the first direction of a main housing.

FIG. 30 is a plan view showing a sliding housing of a sliding apparatus of a sliding type portable terminal according to the fourth exemplary embodiment of the present invention sliding along the first direction of a main housing to face the main housing and be parallel to an upper side of the main housing.

FIG. 31 is a plan view showing a sliding housing of a sliding apparatus of a sliding type portable terminal according to the fourth exemplary embodiment of the present invention sliding along the second direction of a main housing.

FIG. 32 is a plan view showing a sliding housing of a sliding apparatus of a sliding type portable terminal according to the fourth exemplary embodiment of the present invention sliding along the second direction of a main housing to face the main housing and be parallel to an upper side of the main housing.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

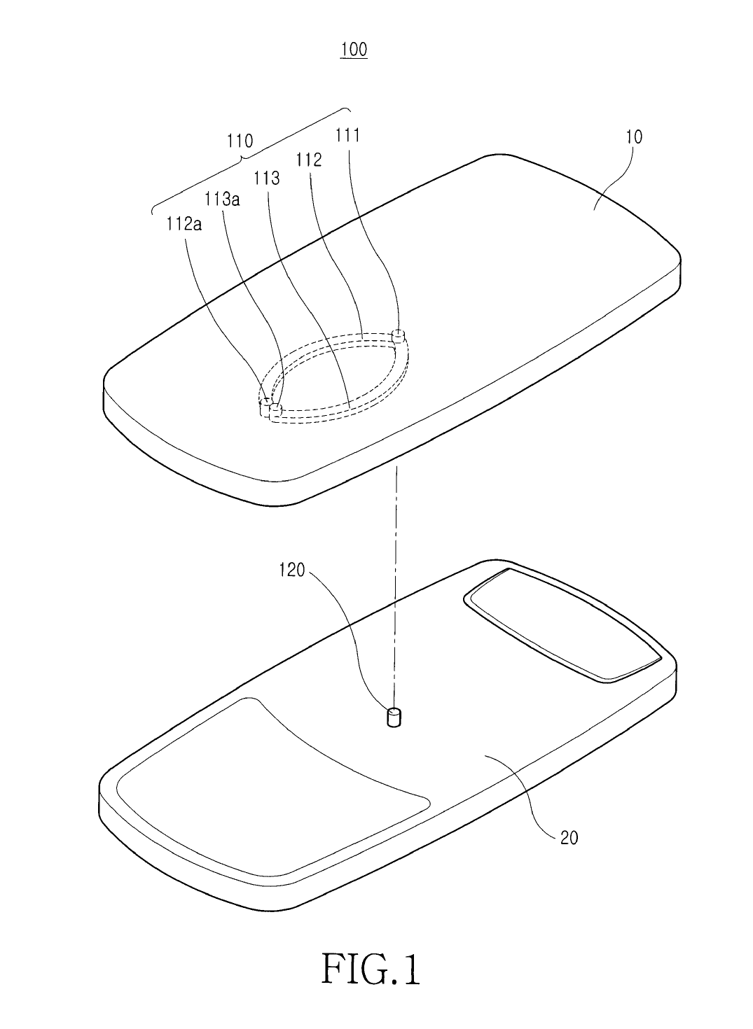

As shown in FIG. 1, a sliding apparatus of a sliding type portable terminal according to an exemplary embodiment of the present invention includes a main housing 20 and a sliding housing 10 slidably coupled with the main housing 20. The main housing 20 includes a fixing member 120. A guide part 110 is included in the sliding housing 10 and may be an integral part of the sliding housing 10. The guide part 110 is engaged with the fixing member 120 to slide along a curved path about the fixing member 120, which acts as a shaft, in one of two directions of the main housing 20 when the sliding housing 10 slides.

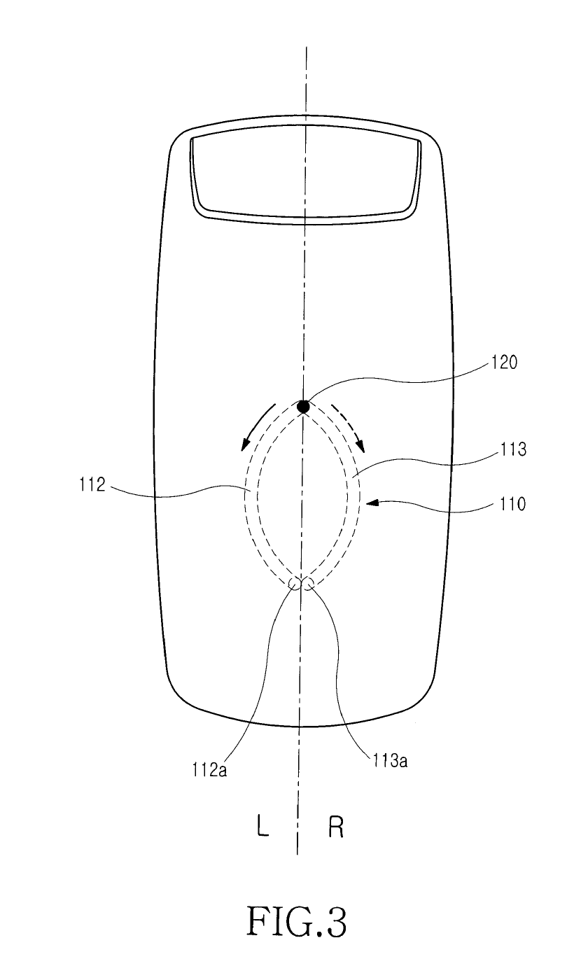

As shown in FIG. 1 and FIG. 3, the fixing member 120 is fixedly coupled with the main housing 20 in such a manner that the fixing member 120 is engaged with the guide part 110 to function as a shaft, about which the sliding housing 10 slides along a curved path, while the guide part 110 slides. The fixing member 120 includes a guide protuberance perpendicularly extending from a surface of the main housing 20 that faces the sliding housing 10.

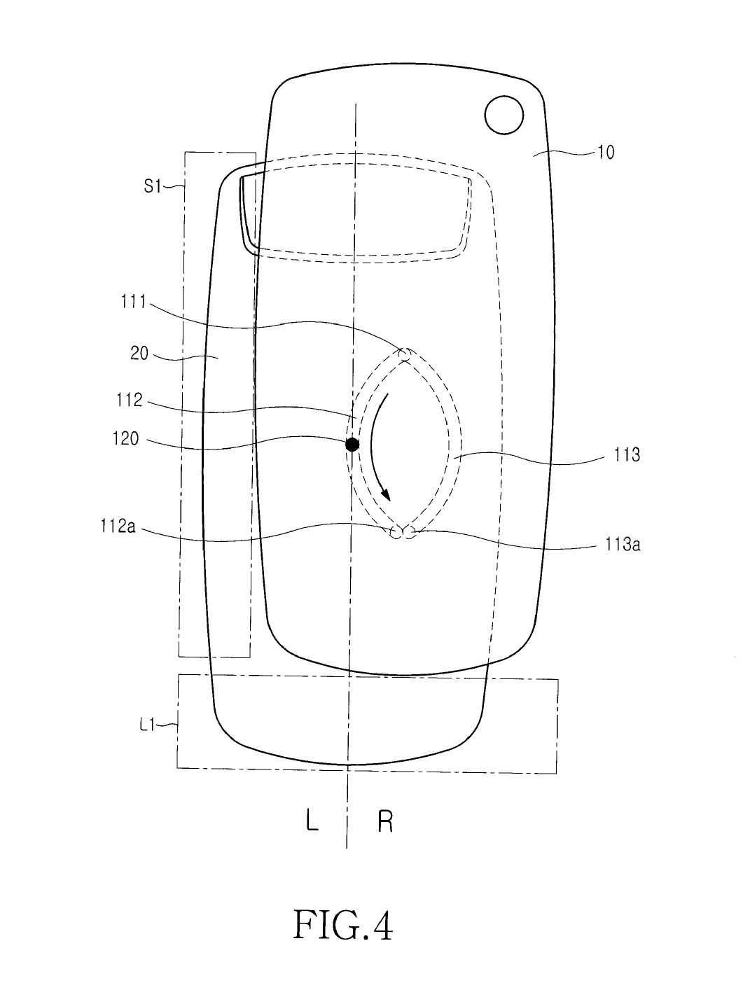

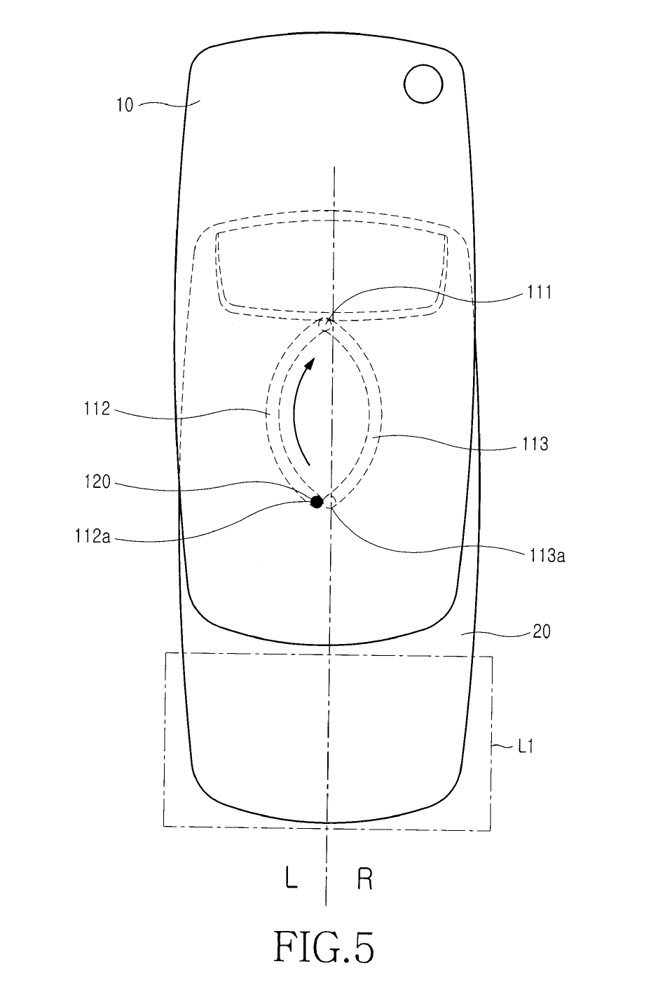

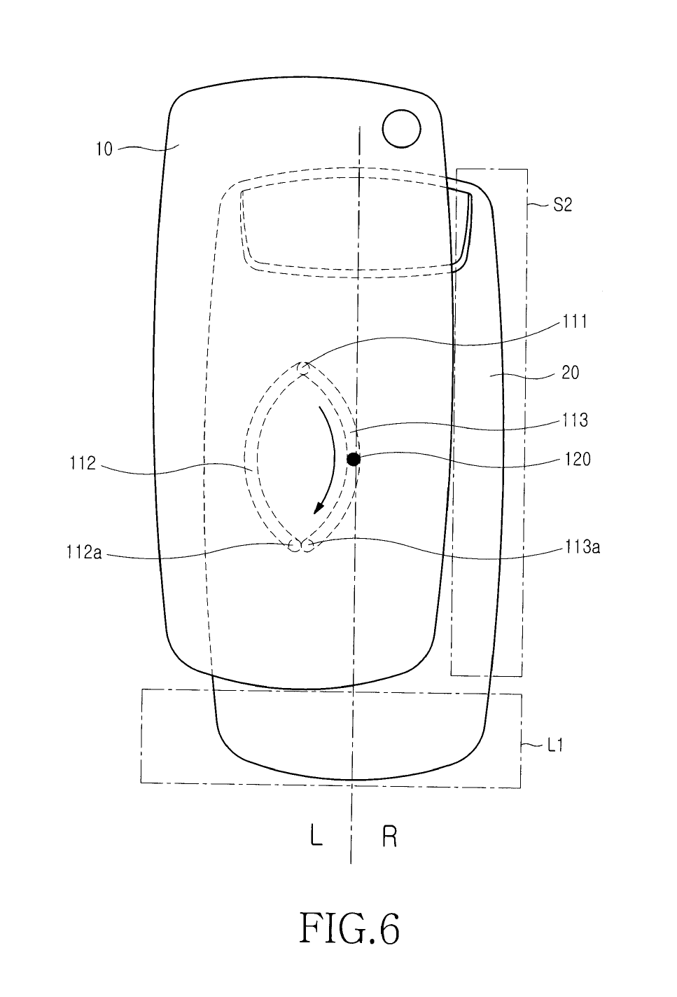

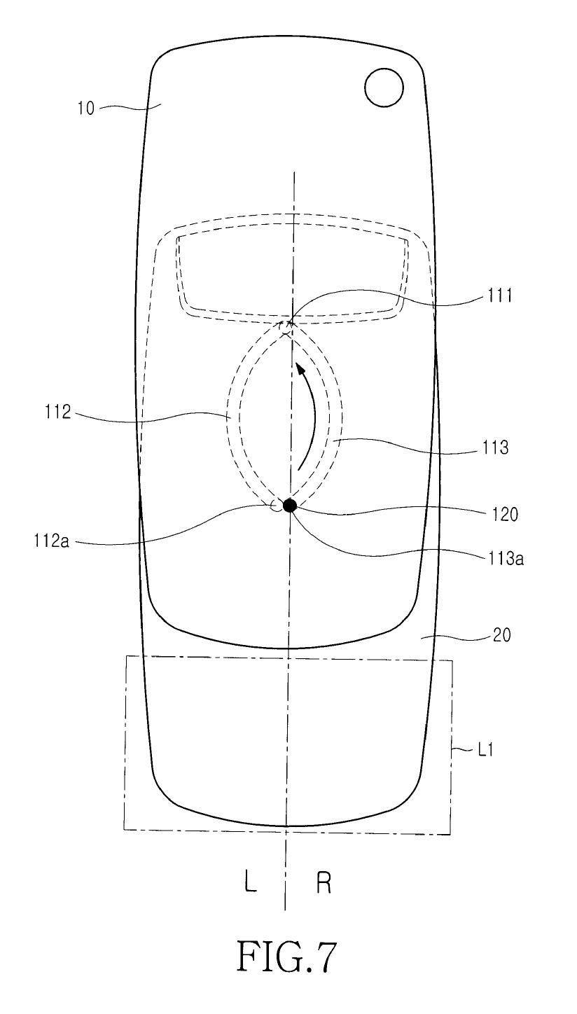

As shown in FIG. 1, FIG. 4 FIG. 5, FIG. 6, FIG. 7, when the sliding housing 10 slides along a curved line in a left direction or a right direction of the main housing 20, a first mode or a second mode may be selectively provided. According to the first mode or the second mode, the sliding housing 10 is adapted to slide along at least one direction of the main housing 20 so as to be opened/closed, and each of the first mode and the second mode includes at least one of a phone mode, a DMB mode, a camera mode, and a game mode.

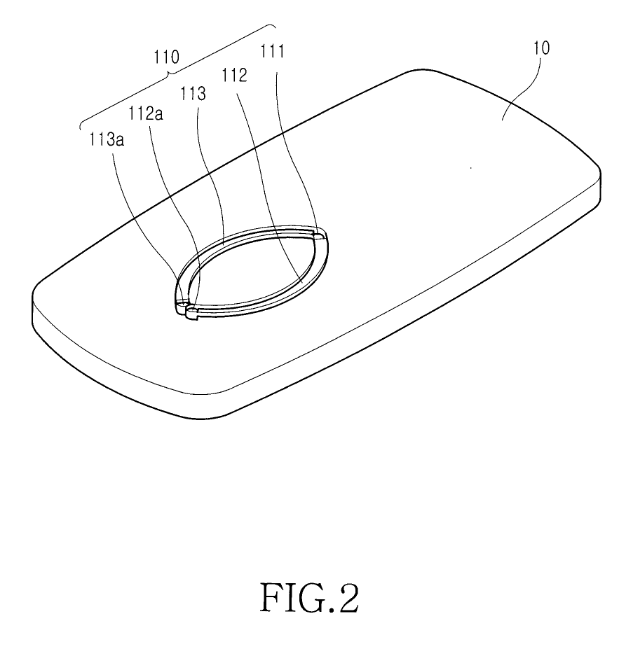

As shown in FIG. 2, when the sliding housing 10 is opened respective to the main housing 20, the guide part 110 is included at a rear surface of the sliding housing 10, at which the main housing 20 and the sliding housing 10 are engaged with each other while facing each other.

As shown in FIG. 1, FIG. 2, FIG. 4, FIG. 5, FIG. 6, and FIG. 7, the guide part 110 includes a locking part 111, a first guide reset part 112, and a second guide reset part 113. The locking part 111 is coupled with the fixing member 120 to allow or restrict the sliding of the sliding housing 10. The first guide reset part 112 is included at one side of the locking part 111 to form a path on the sliding housing along a first direction (L) of the main housing 20 such that a first side area S1 and a lower area L1 of the main housing 20 are opened when the sliding housing 10 slides. The second guide reset part 113 is included at another side of the locking part 111 to form a path on the sliding housing along a second direction (R) of the main housing 20 in such a manner that a second side area S2 and the lower area L1 of the main housing 20 open when the sliding housing 10 slides. The first stopper groove 112a is included at one end of the first guide reset part 112, and the second stopper groove 113a is included at one end of the second guide reset part 113. When the fixing member 120 is positioned at either the locking part 111 or the first stopper groove 112a, the sliding housing 10 is stopped, and when the fixing member 120 is positioned at either the locking part 111 or the second stopper groove 112a, the sliding housing 10 is stopped.

The first guide reset part 112 extends from the locking part 111 to the first stopper groove 112a along a direction in which the sliding housing 10 slides away from the main housing 20 and is centered about the locking part 111, and the second guide reset part 113 extends from the locking part 111 to the second stopper groove 113a along a direction in which the sliding housing 10 slides away from the main housing 20 and is centered about the locking part 111.

As shown in FIG. 3, when the sliding housing 10 is engaged with the main housing 20, the fixing member 120 is locked in the locking part 111 while being engaged therewith, and as shown in FIG. 5, when the sliding housing 10 is positioned at an upper side of the main housing 20 parallel to the main housing 20, the fixing member 120 is locked in the first stopper groove 112a while being engaged therewith.

As shown in FIG. 7, when the sliding housing 10 is positioned at an upper side of the main housing 20 parallel to the main housing 20, the fixing member 120 is locked in the second stopper groove 113a while being engaged therewith. The fixing member 120 is included in the main housing 20 to allow the first guide reset part 112 or the second guide reset part 113 to slide along a curved line about the fixing member 120 when the sliding housing 10 slides while the fixing member 120 is engaged with the locking part 111.

As shown in FIG. 3, the sliding housing 10 overlaps the main housing 20 when the fixing member 120 is located at the locking part III, as shown in FIG. 4, the fixing member 120 opens a lower area L1 and a first side area S1 of one surface of the main housing 20 when the fixing member 120 slides along the first guide reset part 112, as shown in FIG. 5, and the fixing member 120 opens the lower area L1 of the main housing 20 when the fixing member 120 is located at one end of the first guide reset part 112. As shown in FIG. 6 and FIG. 7, The fixing member 120 opens the lower area L1 and a second side area S2 of the surface of the main housing 20 when the fixing member 120 slides along the second guide reset part 113, and the fixing member 120 opens the lower area L1 of the main housing 20 when the fixing member 120 is located at one end of the second guide rest part 113.

Hereinafter, the operation of the sliding apparatus of the sliding type portable terminal according to the first exemplary embodiment of the present invention, which has a structure as described above, will be described in detail with reference to FIG. 1, FIG. 2, FIG. 3, FIG. 4, FIG. 5, FIG. 6, and FIG. 7. According to the state of the sliding type portable terminal being used, it may be separately used in a first mode or a second mode. For example, when the sliding type portable terminal is opened/closed in a first direction of the main housing 20, it may be used in a phone mode, and when the sliding type portable terminal is opened/closed in a second direction (L) of the main housing 20, it may be used in a DMB mode or a camera mode, etc. Therefore, according to the desired mode, the sliding housing 10 may be pushed along a first direction (R) or a second direction (L) of the main housing 20.

As shown in FIG. 3, FIG. 4, and FIG. 5, it is firstly described that the sliding housing 10 slides in a first direction (R) of the main housing 20 to open/close.

To open the sliding housing 10 respective to the main housing 20, the sliding housing 10 is pushed away from the main housing 20. As shown in FIG. 4, since the sliding housing 10 overlaps the main housing 20 when the sliding housing 10 is engaged with the main housing 20 while facing it, one surface of the main housing 20 remains completely covered.

As shown in FIG. 4, when the user slides the sliding housing 10 along a first direction (R) of the main housing 20, the locking part 111 restricting the fixing member 120 is released, thereby freeing the fixing member 120. The fixing member 120 then enters the first guide reset part 112, which includes a path laterally biased toward the first direction (R) of the main housing 20 and the sliding housing 10 slides away from the main housing 20 along the path of the first guide reset part 112.

When the sliding housing 10 is pushed away from the main housing 20, the sliding housing 10 slides along a predetermined curved trace that is laterally biased (deviates) from a center of the main housing 20.

At this time, since the first guide reset part 112 formed in the sliding housing 10 includes a path having a curved shape laterally biased toward the seconddirection (L) of the main housing 20, when the sliding housing 10 slides, the first guide reset part 112 allows the fixing member 120 to move along the path of the first guide reset part 112. The sliding housing 10 slides so as to be opened while sequentially opening the lower area L1 and the first side area S1 as a part of one surface of the main housing 20. At this time, because the curved path of the first guide reset part 112 has a shape of “(”, the first side area S1 of the main housing 20 sequentially becomes wider and again becomes narrower toward an upper side of the main housing 20. As shown in FIG. 5, when the sliding housing 10 protrudes from an upper side of the main housing 20 to be aligned parallel to the main housing, only the lower area L1 of the main housing 20 is opened.

At this time, the fixing member 120 is inserted into the first stopper groove 112a disposed on the first guide reset part 112 to be restricted, and the fixing member 120 is locked in the main housing 20 simultaneously with the stopping of the sliding movement of the sliding housing 10. Also, when the sliding housing 10 is opened respective to the main housing 20, the sliding housing 10 slides toward the main housing 20.

When the sliding housing 10 is pushed, the fixing member 120 slides along the first guide reset part 112 in a direction opposite to the direction that the sliding housing 10 slides away from the main housing 20.

Particularly, the first stopper groove 112a restricting the fixing member 120 is released, and the fixing member 120 also enters the first guide reset part 112.

When the sliding housing 10 is pushed toward the main housing 20, the sliding housing 10 slides along a predetermined curved trace that laterally deviates from a center of the main housing 20 toward the first direction (R) thereof.

The first guide reset part 112 allows the fixing member 120 to move along the path of the first guide reset part 112, as the whole area of the opened lower area L1 of the main housing 20 is reduced, the lower area L1 is covered by the sliding housing 10, and the first side area S1 of the main housing 20 is sequentially opened/closed.

As shown in FIG. 3, as the sliding housing 10 overlaps the main housing 20, the sliding housing 10 covers the whole area of the surface of the main housing 20, so that the sliding housing 10 is engaged with the main housing 20 while facing it.

Then, as shown in FIG. 3, FIG. 6, and FIG. 7, the sliding housing 10 slides in a second direction (L) of the main housing 20 so as to be opened/closed will be described.

As shown in FIG. 3 and FIG. 6, when the user slides the sliding housing 10 in the second direction (L) of the main housing 20, the locking part III restricting the fixing member 120 is released, thereby freeing the fixing member 120.

Additionally, the locking part III allows the fixing member 120 to enter the second guide reset part 113, which includes a path biased toward the first direction (R) of the main housing 20, and the sliding housing 10 deviates from the center of the main housing 20 toward the second direction (L) thereof so as to slide while making a predetermined path about the fixing member 120, which acts as a shaft.

When the sliding housing 10 slides on the main housing 20, the fixing member 120 slides along the curved path of the second guide reset part 113, the sliding housing 10 sequentially opens the lower area L1 and the second side area S2 of the main housing 20 so as to be opened. At this time, since the curved path of the second guide reset part 113 has a shape of “)”, the second side area S2 of the main housing 20 becomes narrower toward an upper side of the main housing 20. As shown in FIG. 7, when the sliding housing 10 protrudes from an upper side of the main housing 20 to be aligned parallel to the main housing 20, only the lower area L1 of the main housing 20 is opened, the fixing member 120 is inserted into the second stopper groove 113a disposed in the second guide reset part 113 to be restricted, and the fixing member 120 is locked in the main housing simultaneously with the stopping of the sliding movement of the sliding housing 10.

As described above, even though the sliding housing 10 is opened respective to the main housing 20, the second guide reset part 113 is positioned at the area where the sliding housing 10 overlaps the main housing 20. Therefore, when the sliding movement of the sliding housing 10 is guided by the first guide reset part 112 or the second guide reset part 113 so that the sliding housing 10 is opened/closed respective to main housing 20, it may be possible to prevent exposure of the rear surface of the sliding housing 10 protruding from the upper side of the main housing 20, thereby making it possible to secure an aesthetic appearance of the sliding type portable terminal.

Also, although not shown, a force supplying unit to supply force to slide the sliding housing 10 may be provided.

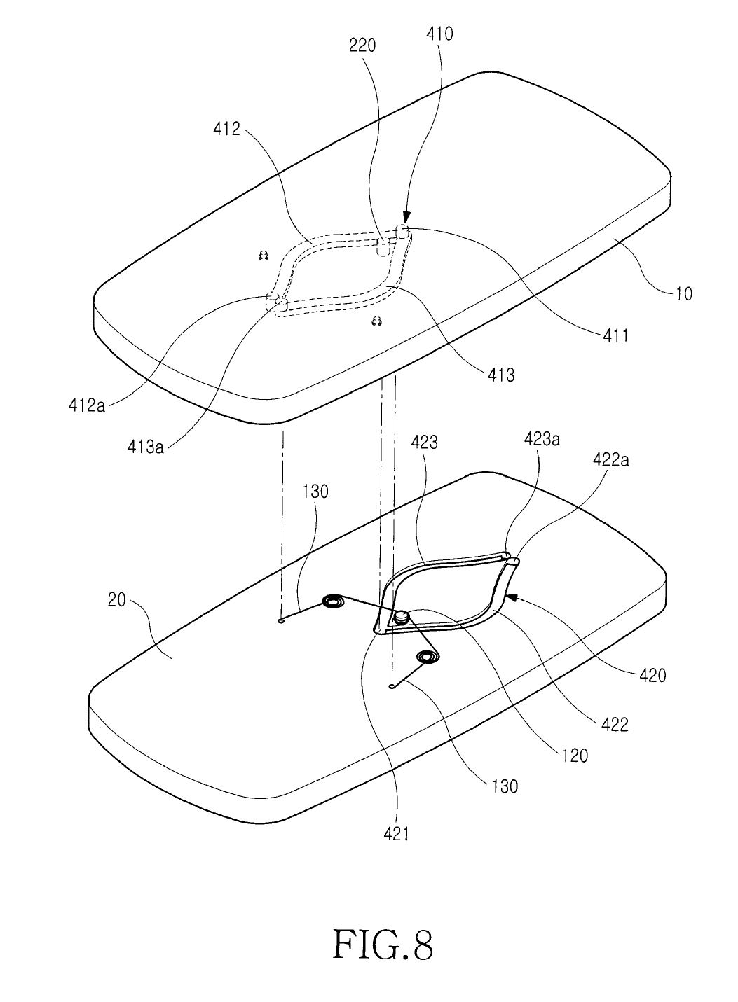

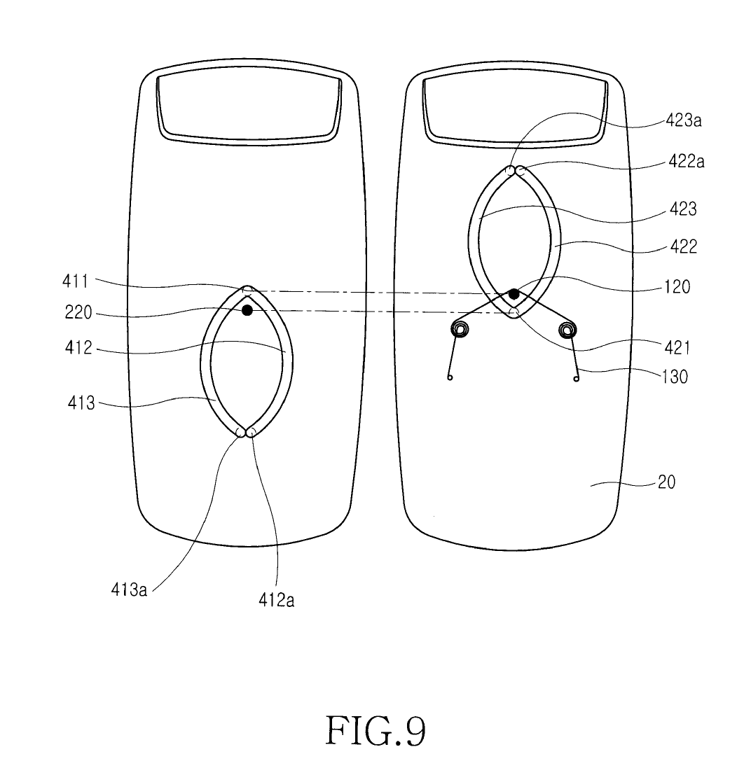

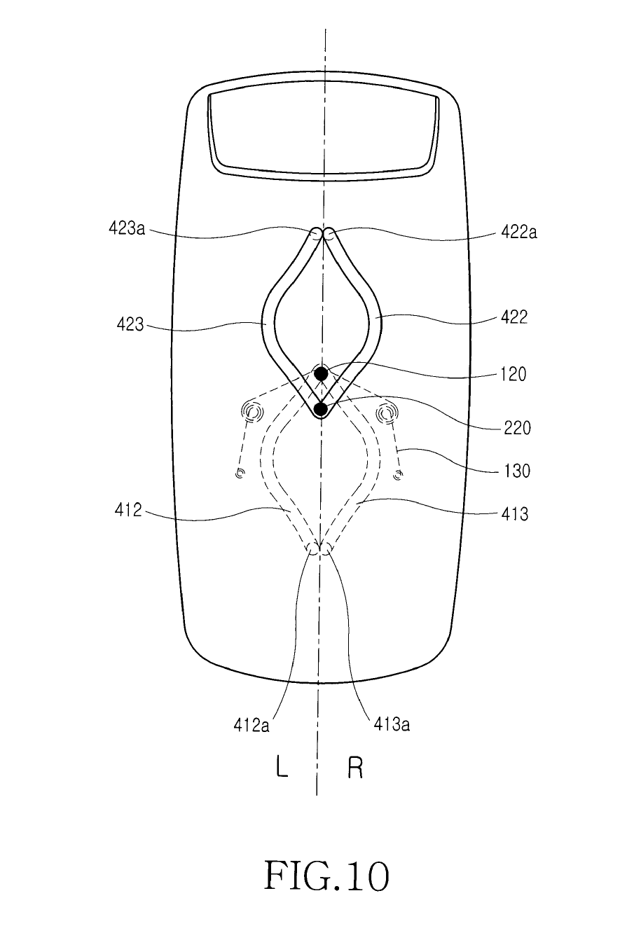

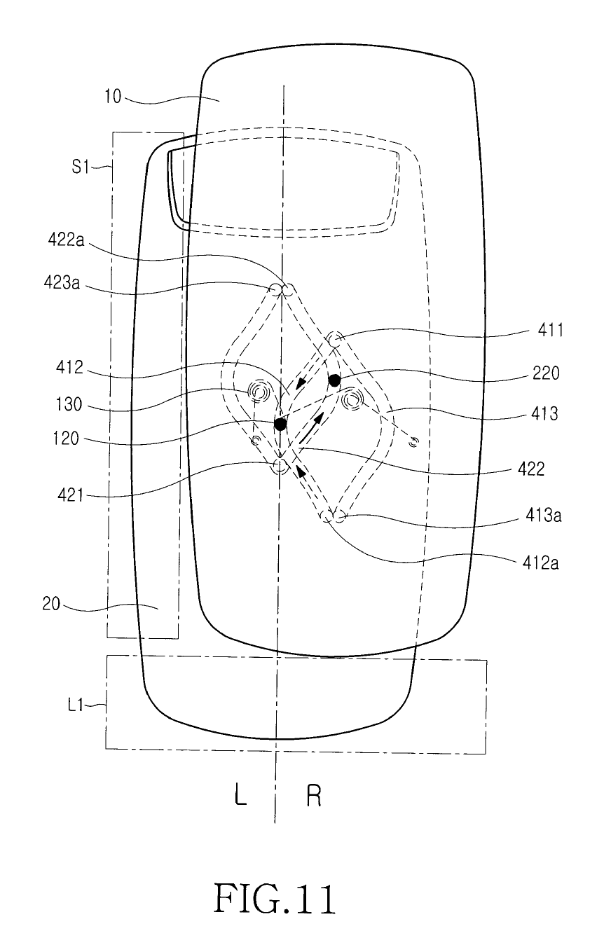

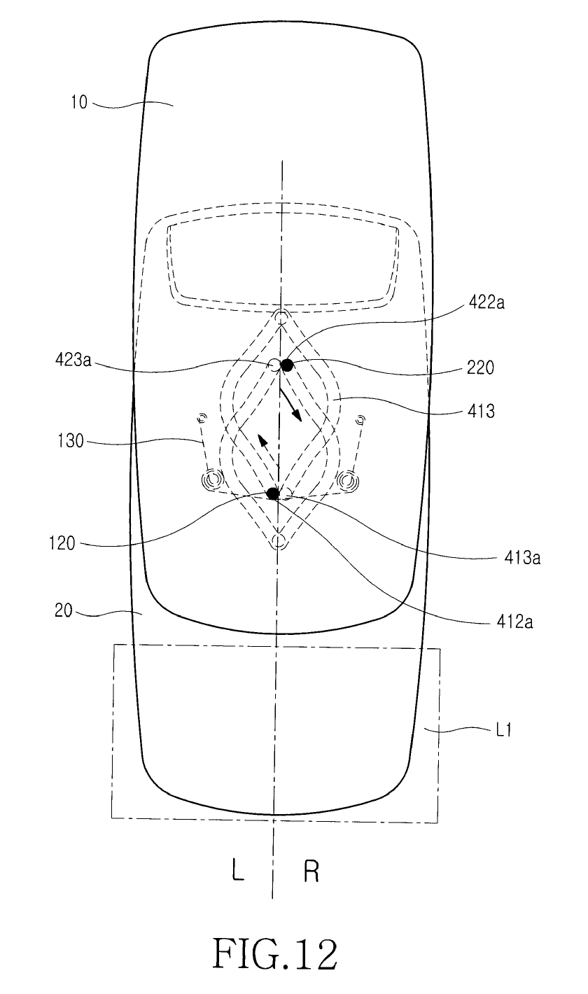

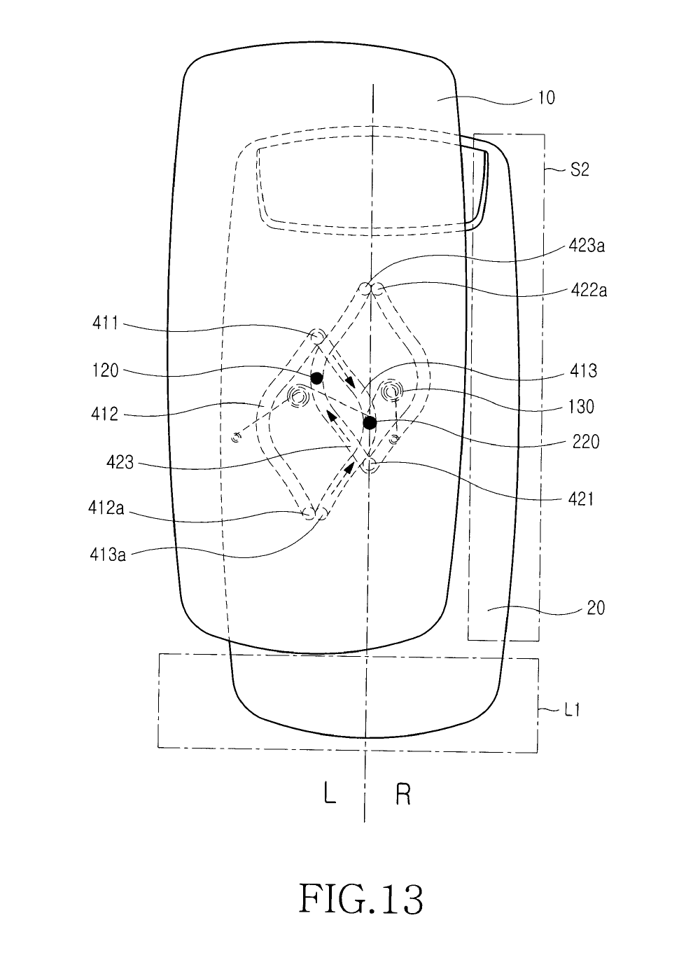

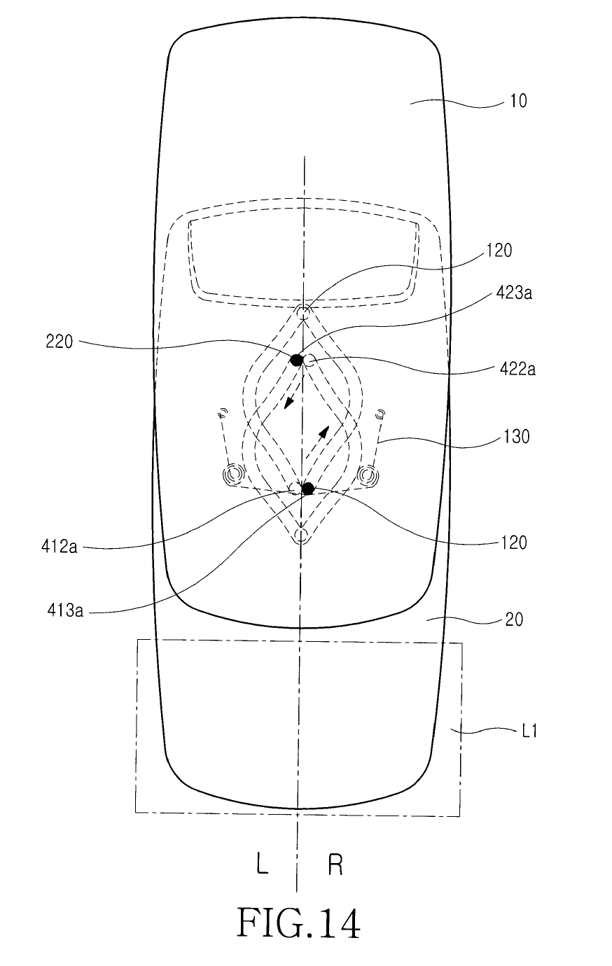

With reference to FIG. 8, FIG. 9, FIG. 10, FIG. 11, FIG. 12, FIG. 13, and FIG. 14, the structure and the operation of a sliding apparatus of a sliding type portable terminal according to the second exemplary embodiment of the present invention having a structure as described above will be described.

The sliding type portable terminal includes a main housing 20 and a sliding housing 10. The main housing 20 includes the first fixing member 120 including a guide protuberance perpendicularly extending from one surface thereof and facing the sliding housing 10 and the second guide part 420. The sliding housing 10 includes the second fixing member 220 including a guide protuberance perpendicularly extending from one surface thereof and facing the main housing 20 and the first guide part 410.

The first fixing member 120 is engaged with the first guide part 410, and the second fixing member 220 is engaged with the second guide part 420. The first guide part 410 and the second guide part 420 may be curved paths having the same shape as each other. The first guide part 410 includes the first locking part 411 and the first and second guide reset parts 412 and 413, and the second guide part 420 includes the second locking part 421 and the third and fourth guide reset parts 422 and 423.

The first and second guide reset parts 412 and 413 and the third and fourth guide reset parts 422 and 423 each include a curved path, and at a surface where the sliding housing 10 and the main housing 20 face each other, the first and fourth guide reset parts 412 and 423 curve in the same direction, and the second and third guide reset parts 413 and 422 curve in the same direction. The first guide reset part 412 formed in the sliding housing (10) includes a path in a second direction (L) of the main housing 20 and is centered about an imaginary line connecting the first locking part 411 and the first stopper groove 412a, and the fourth guide reset part 423 includes a curved path in the second direction (L) of the main housing 20 and is centered about an imaginary line connecting the second locking part 421 and the fourth stopper groove 423a.

The second guide reset part 413 formed in the sliding housing (10) includes a path in the first direction (R) of the main housing 20, which is opposite the second direction (L), and is centered about an imaginary line connecting the first locking groove 411 and the second stopper groove 413a, and the third guide reset part 422 includes a path in the firstdirection (R) of the main housing 20 and is centered about an imaginary line connecting the second locking groove 421 and the third stopper groove 422a. Also, a force supplying unit to supply force to slide the sliding housing is included and may, for example, be a coil spring. The coil spring has free ends extending away from a coil part to both ends thereof, respectively. One free end of the coil spring is mounted on the first fixing member, and the other free end of the coil spring is mounted on a supporting protuberance disposed on the sliding housing.

As shown in FIG. 10, FIG. 11, and FIG. 12, the sliding of the sliding housing 10 in the first direction (R) of the main housing to open/close the sliding housing 10 will be described.

As shown in FIG. 10 and FIG. 11, when the sliding housing 10 and the main housing 20 are engaged with each other and face each other, the sliding housing 10 may be opened respective to the main housing 20 by sliding the sliding housing 10 away from the main housing 20.

As shown in FIG. 10, when the sliding housing 10 and the main housing 20 are engaged with each other and face each other, the sliding housing 10 overlaps the main housing 20 so one surface of the main housing 20 remains completely covered.

As shown in FIG. 11, when the sliding housing 10 is pushed in a first direction (R) of the main housing 20, the first fixing member 120 is released from the first locking part 411 and enters the first guide reset part 412, and the second fixing member 220 is released from the second locking part 421 and enters the third guide reset part 422

Accordingly, as the sliding housing 10 slides while turning about the first and second fixing members 120 and 220, a first side area S1 and a lower area L1 of the main housing 20 are sequentially opened/closed. As shown in FIG. 12, when the sliding housing 10 protrudes from an upper side of the main housing 20 to be aligned parallel to the main housing 20, the first fixing member 120 and the second fixing member 220 are engaged with the first stopper groove 412a and the third stopper groove 422a so as to be fixed, respectively, so that the sliding housing 10 can be opened.

As shown in FIG. 10, the whole area of one surface of the main housing 20 may be covered by overlapping the sliding housing 10 on the main housing 20 by sliding the sliding housing 10 toward the main housing 20.

Accordingly, as shown in FIG. 11, the first fixing member 120 is released from the first stopper groove 412a and enters the first guide reset part 412, and the second fixing member 220 is released from the third stopper groove 422a and enters the third guide reset part 422 so that the first side area S1 is sequentially opened and closed and the lower area L1 is closed.

As shown in FIG. 10, the first fixing member 120 is engaged with the first locking part 411, and the second fixing member 220 is engaged with the second locking part 421, such that the sliding housing 10 overlaps the main housing 20 so as to be closed.

As shown in FIG. 10, FIG. 13, and FIG. 14, the sliding of the sliding housing 10 in the second direction (L) of the main housing 20 to open/close the sliding housing 10 will be described below.

As shown in FIG. 13, when the sliding housing 10 is pushed in the second direction (L) of the main housing 20, the first fixing member 120 is released from the first locking part 411 and enters the second guide reset part 413, and the second fixing member 220 is simultaneously released from the second locking part 421 and enters the fourth guide reset part 423. Accordingly, the second side area S2 and the lower area L1 of the main housing 20 are sequentially opened/closed. As shown in FIG. 14, the first fixing member 120 is engaged with the second stopper groove 413a disposed at one end of the second guide reset part 413, and the second fixing member 220 is engaged with the fourth stopper groove 423a disposed at one end of the fourth guide reset part 423 Thus, the sliding housing 10 simultaneously protrudes from an upper side of the main housing 20 in a direction parallel to the main housing 20 so as to be opened while facing the main housing 20.

To close the whole area of one surface of the main housing 20 by overlapping the sliding housing 10 on the main housing 20, the user slides the sliding housing 10 toward the main housing 20.

Accordingly, as shown in FIG. 13, the first fixing member 120 is released from the second stopper groove 413a and simultaneously enters the second guide reset part 413, and the second fixing member 220 is released from the fourth stopper groove 423a and simultaneously enters the fourth guide reset part 423, such that the first side area S1 and the lower area L1 are sequentially opened/closed.

As shown in FIG. 10, the first fixing member 120 is engaged with the first locking part 411, and the second fixing member 220 is engaged with the second locking part 421, such that the sliding housing 10 simultaneously overlaps the main housing 20 so as to be closed.

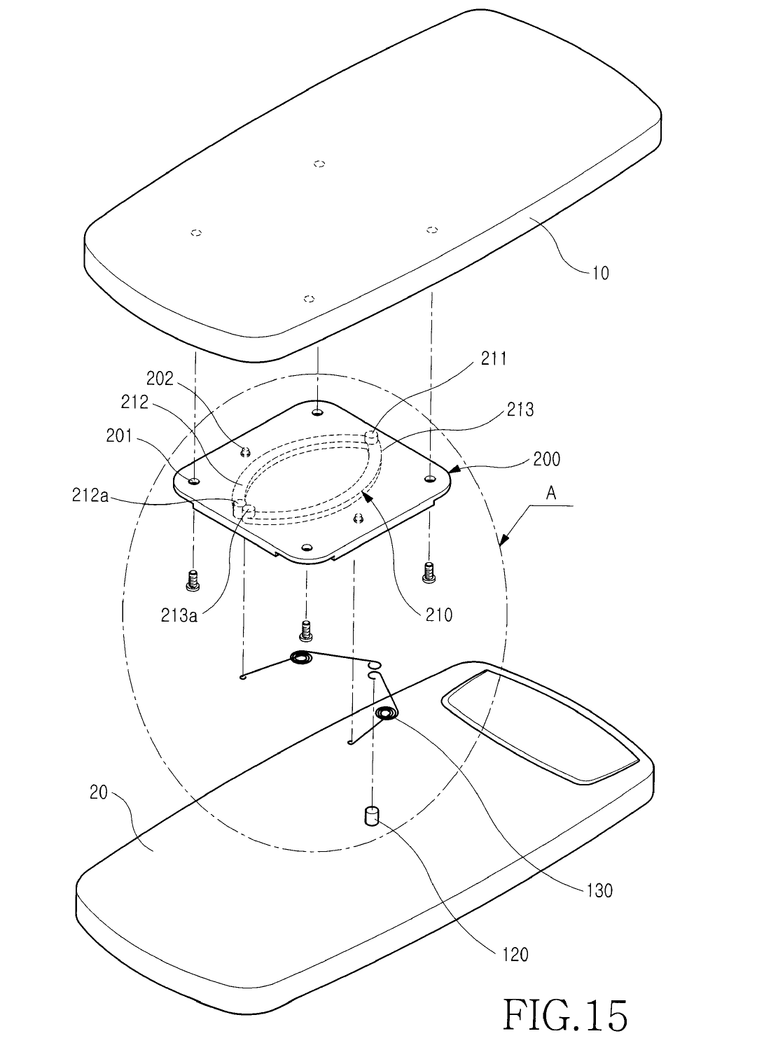

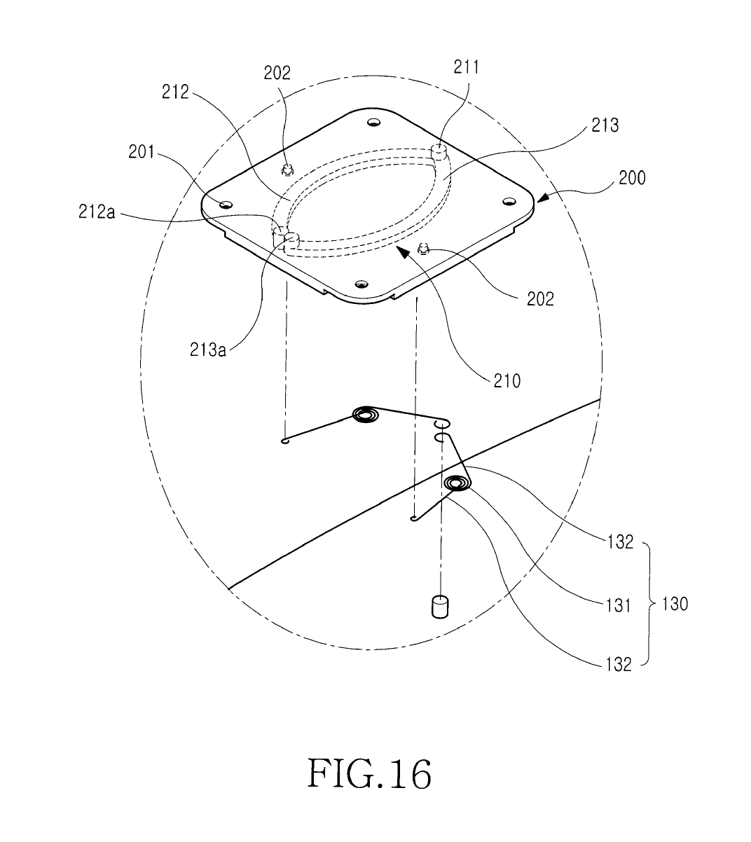

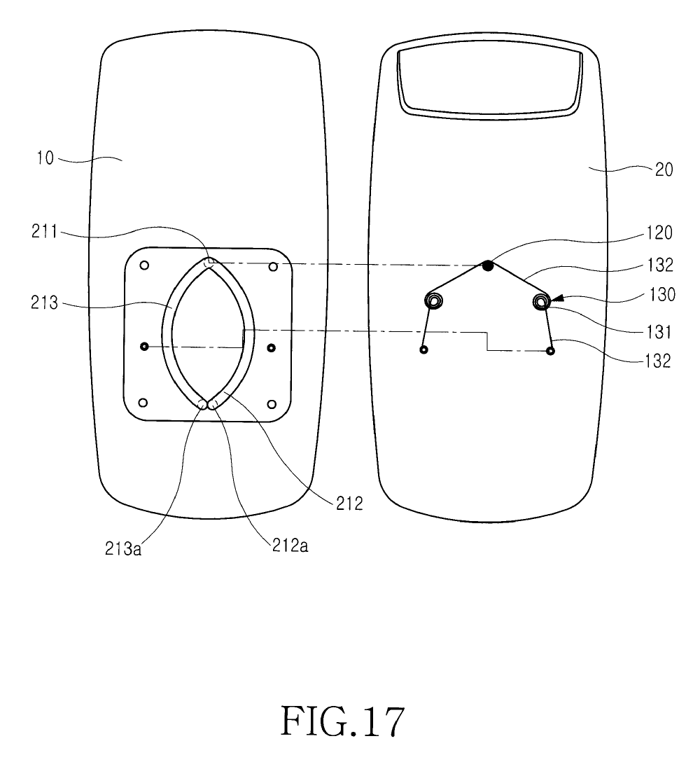

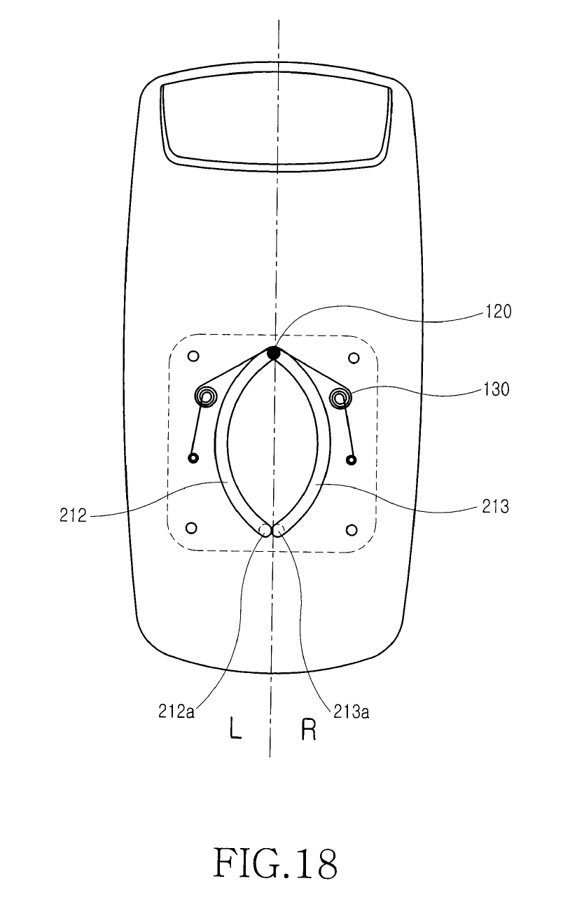

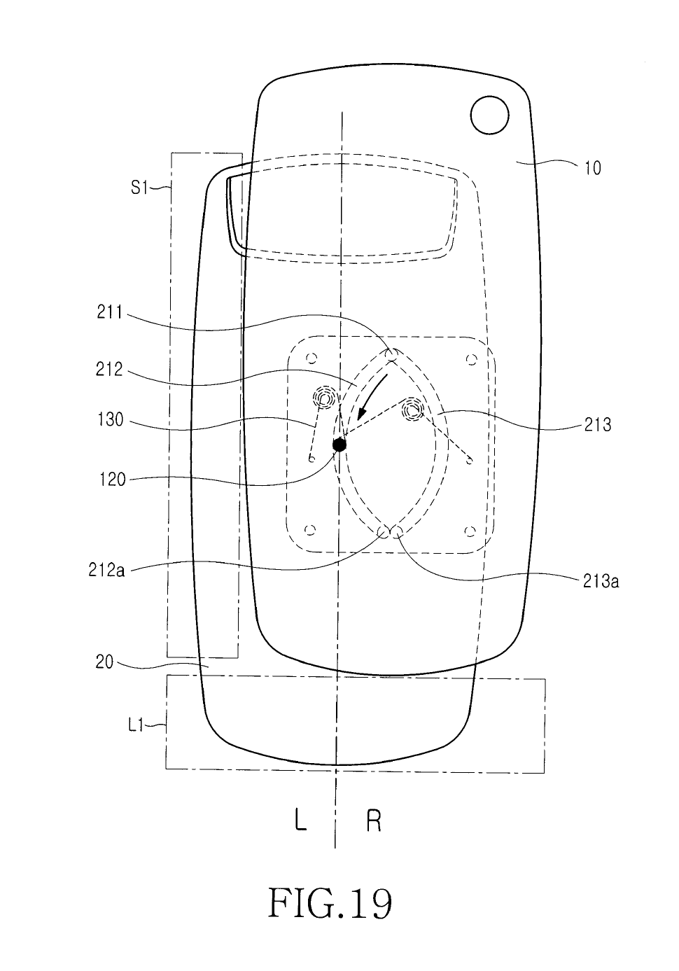

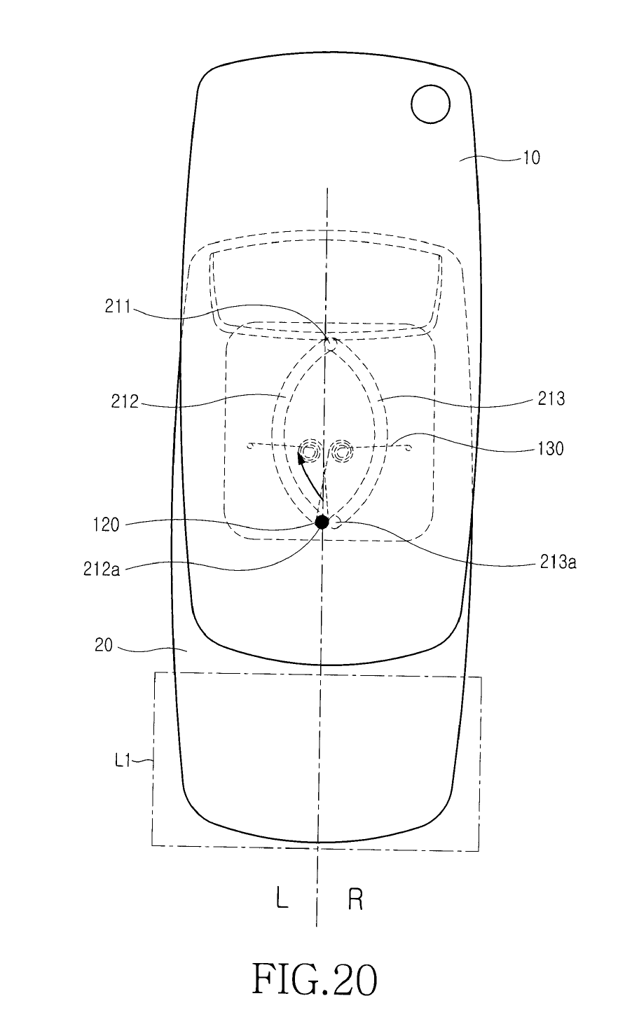

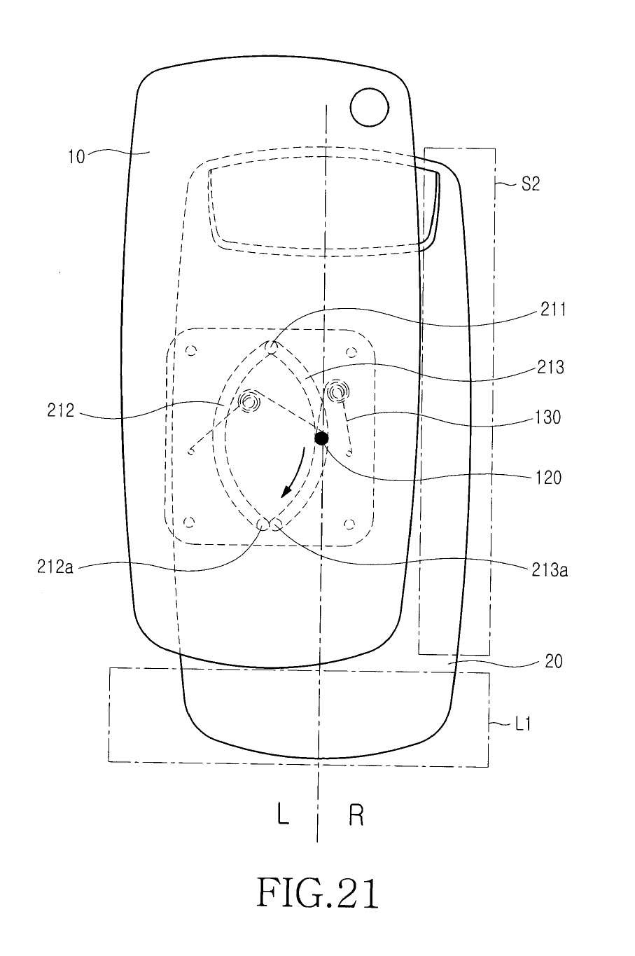

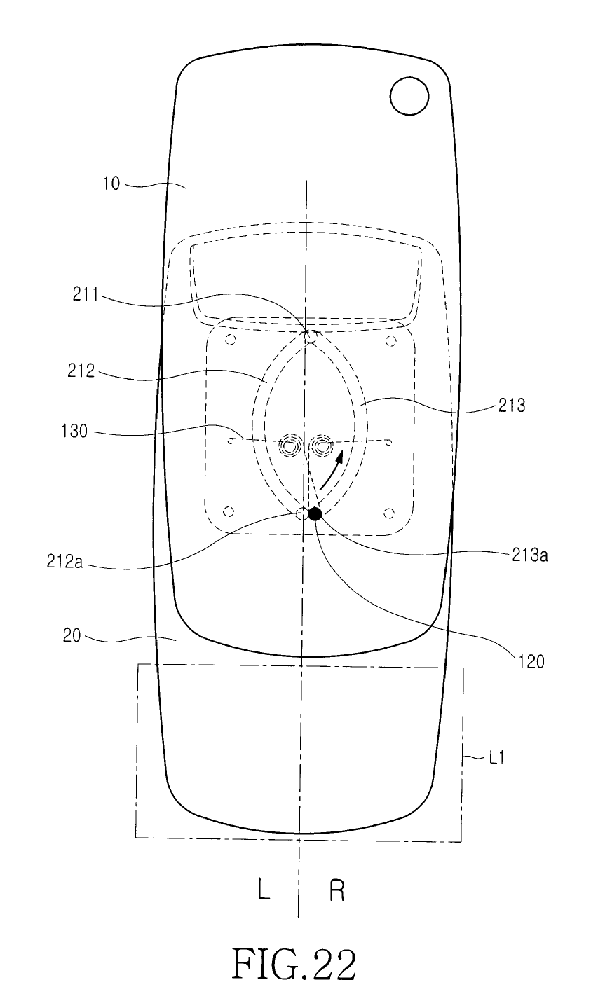

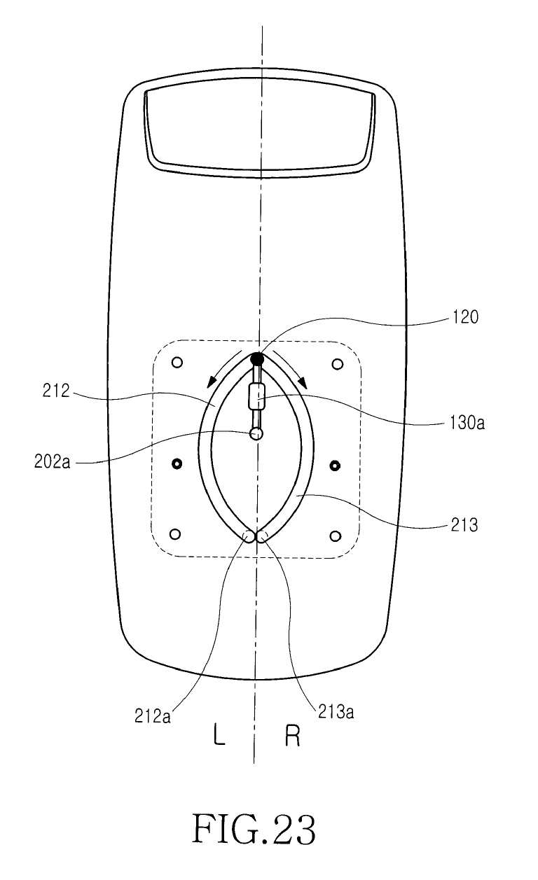

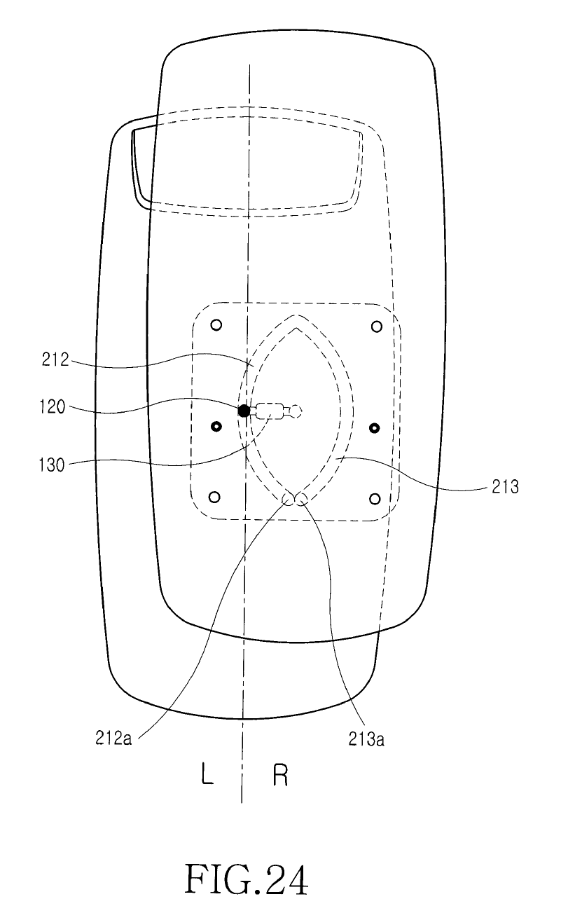

With reference to FIG. 15, FIG. 16, FIG. 17, FIG. 18, FIG. 19, FIG. 20, FIG. 21, FIG. 22, FIG. 23, and FIG. 24, the structure and operation of a sliding apparatus of a sliding type portable terminal according to the third exemplary embodiment of the present invention will be described in more detail below. As shown in FIG. 15, the sliding type portable terminal includes a main housing 20 having a fixing member 120 and a sliding housing 10 having a guide member 200.

As shown in FIG. 15 and FIG. 17, the fixing member 120 is a guide protuberance 120 perpendicularly extending from one surface of the main housing 20 that faces the sliding housing 10, and functions as a shaft while the sliding housing 10 slides along a path on the main housing 20. As shown in FIG. 16, a guide member 200 is included at a rear surface of the sliding housing 10 and has a guide part 210 including a groove having a predetermined path on a surface of the sliding housing 10 that faces the main housing 20. The guide member 200 may be coupled to the sliding housing 10 with screws.

The guide part 210 is engaged with the fixing member 120, and the guide part 210 turns along the path on the main housing 20 about the fixing member 120, which acts as a shaft, when the sliding housing 10 slides open/closed.

Also, supporting protuberances 202 are disposed on a surface of the guide member 200 that faces the main housing 20 to allow a force supplying unit 130 to supply force to slide the sliding housing 10 mounted thereon.

The guide part 210 includes a locking part 211, the first guide reset part 212, and the second guide reset part 213. Because the configurations of these are same as those of the first exemplary embodiment, a detailed description of them will be omitted. The supporting protuberances 202 may be disposed at the exterior of the path of the guide part 210 and, as shown in FIG. 16, they may be disposed at the interior of the path of the guide part 210.

The force supplying unit 130 may include a coil part 131 and free ends 132 extending away from the coil part 131. One of the free ends 132 is mounted on the fixing member 120, and the other free end 132 is mounted on the supporting protuberance 202.

According to a selected mode of the sliding type portable terminal, the user slides the sliding housing 10 such that the sliding housing 10 turns along a first direction or a second direction of the main housing 20.

As shown in FIG. 18, FIG. 19, and FIG. 20, the sliding of the sliding housing 10 in the first direction (R) of the main housing 20 to open/close the sliding housing will be described. To open the sliding housing 10 respective to the main housing 20, the user slides the sliding housing 10 away from the main housing 20.

As shown in FIG. 18, since the sliding housing 10 overlaps the main housing 20, one surface of the main housing 20 remains completely covered.

As shown in FIG. 19, when the sliding housing 10 is pushed in the first direction (R) of the main housing 20, the fixing member 120 is released from the locking part 211 and simultaneously enters the first guide reset part 212 so that a first side area S1 and a lower area L1 of the main housing 20 are sequentially opened/closed. As shown in FIG. 20, the fixing member 120 is engaged with the first stopper groove 212a disposed at one end of the first guide reset part 212, and the sliding housing 10 simultaneously protrudes from an upper side of the main housing 20 to be aligned parallel with the main housing 20 so that the sliding housing 10 is opened while facing the main housing 20.

An operation of the force supplying unit 130 when the sliding housing 10 is opened is now briefly described in FIG. 18 and FIG. 19. As the sliding housing 10 slides, one part of the coil spring 130 coupled with the supporting protuberance 202 of one side of the guide member 200 and the other part of the coil spring 130 coupled with the supporting protuberance 202 of the other side of the guide member 200, with reference to the fixing member 120, are compressed and extended, respectively. Therefore, the coil spring 130 is located as shown in FIG. 20 and keeps the sliding housing 10 open.

As shown in FIG. 18, to cover the whole area of the one surface of the main housing 20 by overlapping the sliding housing 10 on the main housing 20, the user slides the sliding housing 10 toward the main housing 20.

Accordingly, as shown in FIG. 19, the first fixing member 120 is released from the first stopper groove 212a to enter the first guide reset part 212, so that the one side area S1 and the lower area L1 are sequentially opened/closed. As shown in FIG. 18, the fixing member 120 is locked in the locking part 211, and the sliding housing 10 simultaneously overlaps the main housing 20 so as to be closed.

Also, an operation of the force supplying unit 130 when the sliding housing 10 is closed is now briefly described. As the sliding housing 10 slides, one part of the coil spring 130 coupled with the supporting protuberance 202 of one side of the guide member 200 and the other part of the coil spring 130 coupled with the supporting protuberance 202 of the other side thereof, with reference to the fixing member 120, are compressed and extended, respectively. Therefore, the coil spring 130 keeps the sliding housing 10 closed

On the other hand, as shown in FIG. 18, FIG. 21, and FIG. 22, the operation of the sliding housing 10 sliding in the second direction (L) of the main housing 20 so as to be opened/closed will be described. As shown in FIG. 18 and FIG. 21, when the sliding housing 10 is pushed in the second direction (L) of the main housing 20, the fixing member 120 is released from the locking part 211 and enters the second guide reset part 213 so that a second side area S2 and the lower area L1 of the main housing 20 are sequentially opened/closed. As shown in FIG. 22, the fixing member 120 is engaged with the second stopper groove 213a disposed at one end of the second guide reset part 213, and the sliding housing simultaneously protrudes from an upper side of the main housing 20 so as to be aligned parallel to the main housing 20 so that the sliding housing is opened while facing the main housing 20.

An operation of the force supplying unit 130 when the sliding housing 10 is opened is described below. As the sliding housing 10 slides, one part of the coil spring 130 coupled with the supporting protuberance 202 of one side of the guide member 200 and the other part of the coil spring 130 coupled with the supporting protuberance 202 of the other side thereof, with reference to the fixing member 120, are compressed and extended, respectively. Therefore, the coil spring 130 allows sliding of the sliding housing 10 and keeps the sliding housing 10 open. In this state, as shown in FIG. 18, the user slides the sliding housing 10 toward the main housing 20 so as to close the whole area of one surface of the main housing 20 by overlapping the sliding housing 10 on the main housing 20.

Accordingly, as shown in FIG. 21, the fixing member 120 is released from the second stopper groove 213a and simultaneously enters the second guide reset part 213, so that the second side area S2 and the lower area L1 are sequentially opened/closed. As shown in FIG. 18, the first member 120 is engaged with the locking part 211, and the sliding housing 10 simultaneously overlaps the main housing 20 so as to be closed.

Also, an operation of the force supplying unit 130 when the sliding housing 10 is closed is now briefly described. As the sliding housing 10 slides, one part of the coil spring 130 coupled with the supporting protuberance 202 of one side of the guide member 200 and the other part of the coil spring 130 coupled with the supporting protuberance 202 of the other side of the guide member 200, with reference to the fixing member 120, are compressed and extended, respectively. Therefore, the coil spring 130 keeps the sliding housing 10 closed.

Furthermore, as shown in FIG. 23 and FIG. 24, the force supplying unit 130 may include a push rod 130 mounted thereon. The push rod may include one free end 132 at one side thereof mounted on the fixing member 120, and another free end 132 at the other side thereof mounted on the sliding housing 10, so that the force supply unit 130 may supply force to drive the sliding of the sliding housing 10.

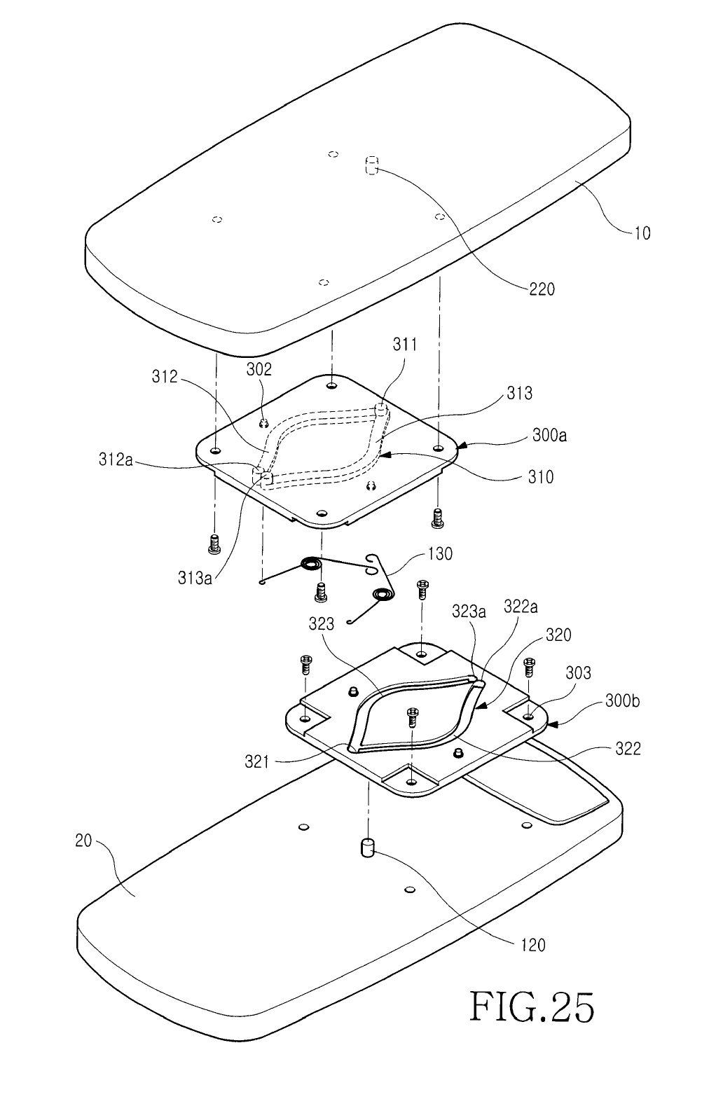

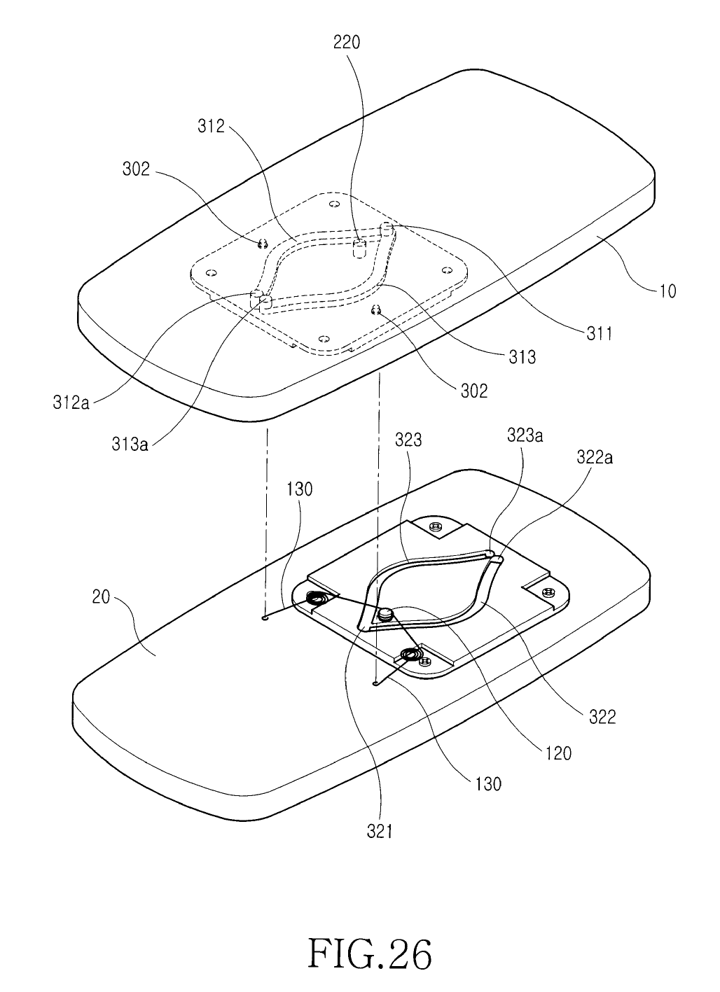

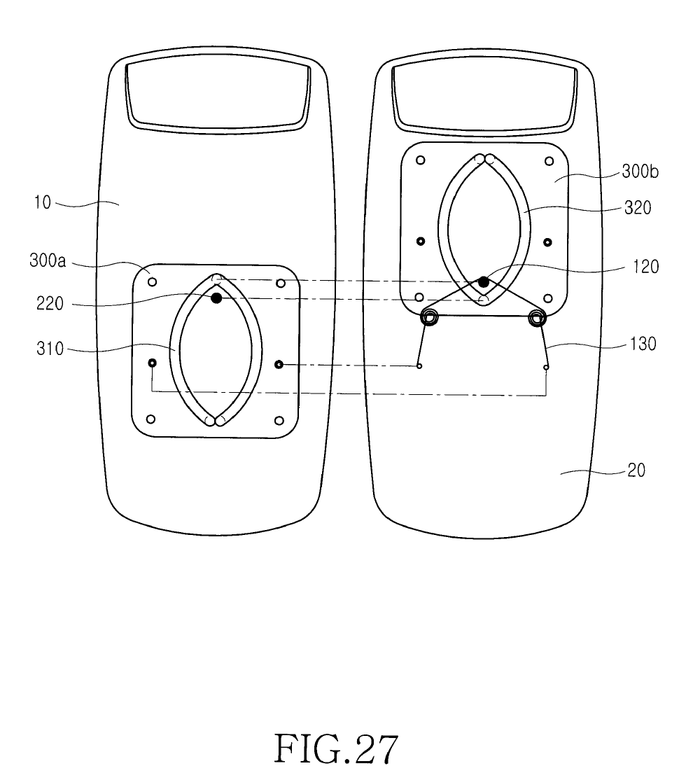

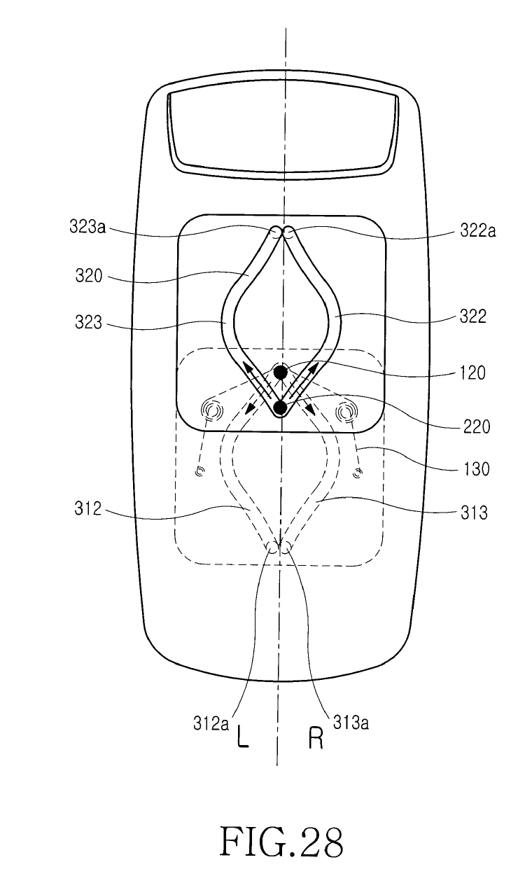

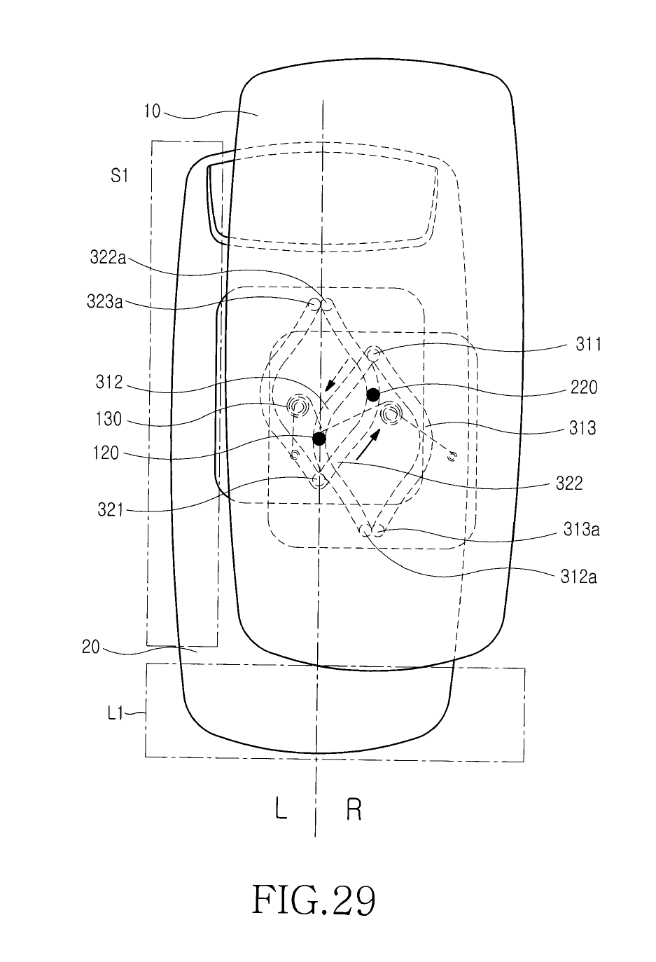

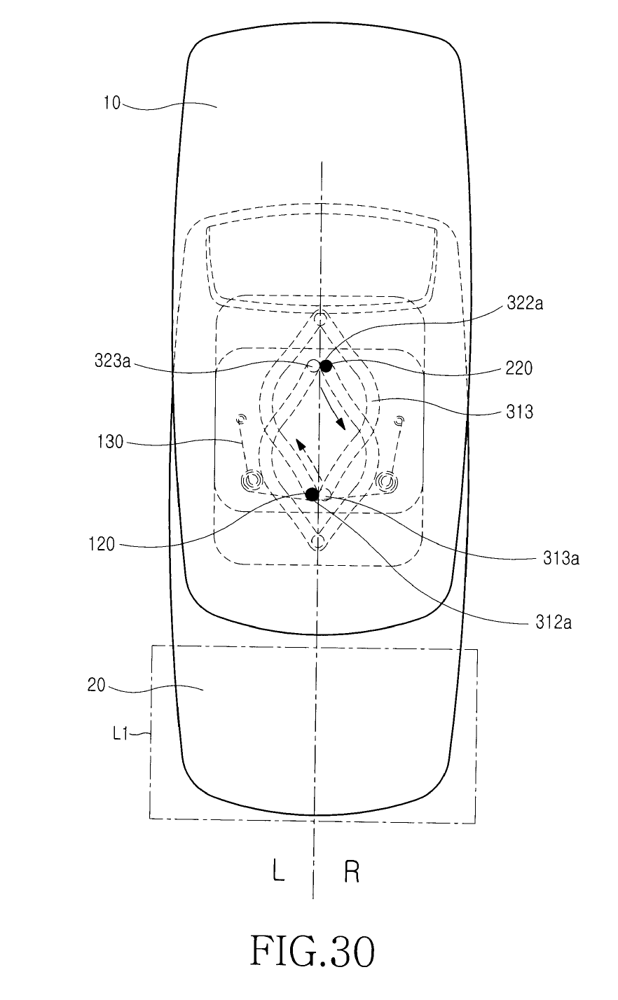

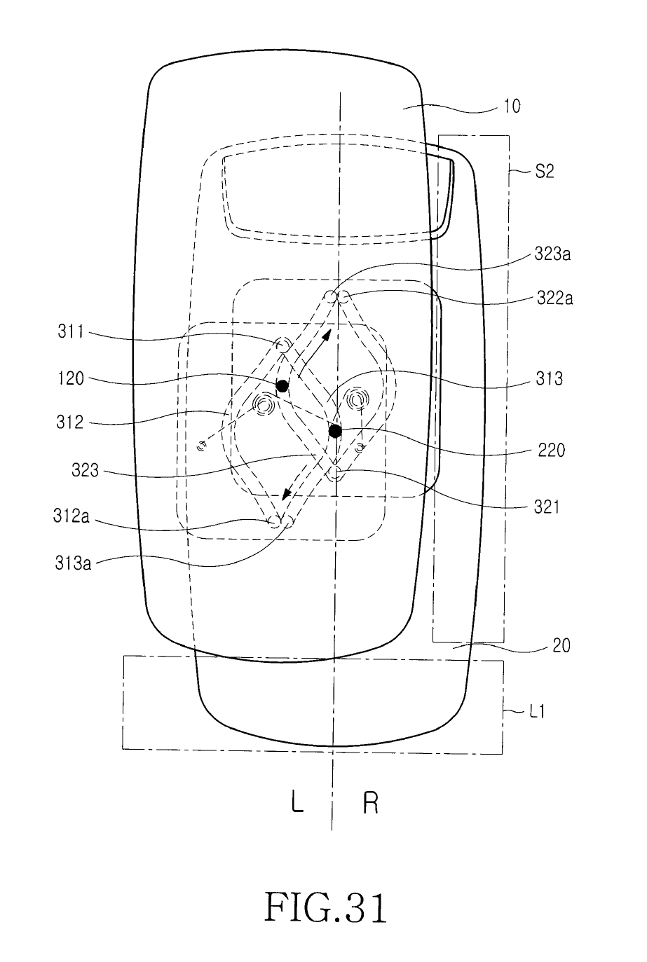

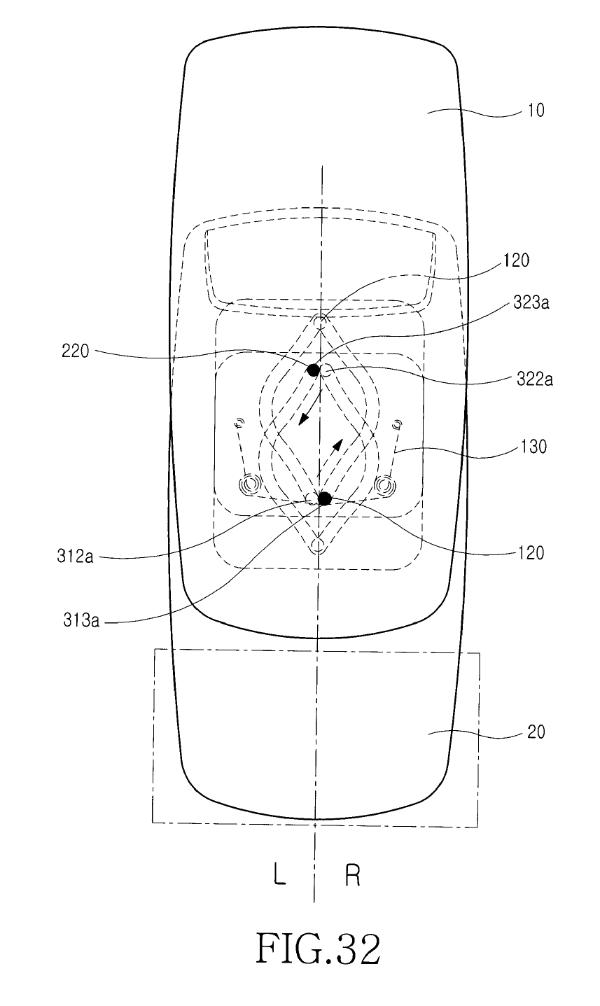

With reference to FIG. 25, FIG. 26, FIG. 27, FIG. 28, FIG. 29, FIG. 30, FIG. 31, and FIG. 32, the structure and the operation of a sliding apparatus of a sliding type portable terminal according to the fourth exemplary embodiment of the present invention will be described in more detail. As shown in FIG. 25, the sliding type portable terminal according to the fourth exemplary embodiment includes a main housing 20 and a sliding housing 10. The main housing 20 includes a first fixing member 120 including a guide protuberance perpendicularly extending from one surface thereof facing the sliding housing 10 and the second guide member 300b including the second guide part 320. The sliding housing 10 includes a second fixing member 220 including a guide protuberance perpendicularly extending from one surface thereof facing the main housing 20 and the first guide member 300a including the first guide part 310.

As shown in FIG. 25, FIG. 26, FIG. 27, and FIG. 28, the first fixing member 120 perpendicularly extends from a surface of the main housing 20 that faces the sliding housing 10 and is engaged with the first guide part 310 mounted on the sliding housing 10. The second fixing member 220 perpendicularly extends from a surface of the sliding housing 10 that faces the main housing 20 and is engaged with the second guide part 320 mounted on the main housing 20.

The first guide part 310 and the second guide part 320 may each include a path having the same shape as each other. The first guide part 310 includes the first locking part 311 and the first and second guide reset parts 312 and 313, and the second guide part 320 includes the second locking part 321 and the third and fourth guide reset parts 322 and 323.

The first and second guide reset parts 312 and 313 and the third and fourth guide reset parts 322 and 323 each form a predetermined path, the paths of the first and fourth guide reset parts 312 and 323 being shaped in the same direction, and the paths of the second the third guide reset parts 313 and 322 being shaped in the same direction.

The first guide reset part 312 formed in first guide member 300a includes a path in a second direction (L) of the main housing 20 and centered about an imaginary line connecting the first locking part 311 to the first stopper groove 312a, and the fourth guide reset part 323 formed in the second guide member 300b includes a path in the second direction (L) of the main housing 20 and centered about an imaginary line connecting the second locking part 321 to the fourth stopper groove 323a

The second guide reset part 313 formed in first guide member 300a includes a path in the first direction (R) of the main housing 20 and centered about an imaginary line connecting the first locking part 311 to the second stopper groove 313a, and the third guide reset part 322 the second guide member 300b includes a path in the first direction (L) of the main housing 20 and centered about an imaginary line connecting the second locking part 321 to the third stopper groove 322a. Also, a force supplying unit 130 to supply force to slide the sliding housing 10 is included between the first guide member 300a and the second guide member 300b, and the force supplying unit 130 may be a coil spring 130. The coil spring 130 has free ends 132 extending away from a coil part 131 of the coil spring 130. One free end 132 of the coil spring 130 is mounted on the first fixing member 120, and the other free end 132 of the other end of the coil spring 130 is mounted on a supporting protuberance 302 disposed on the first guide member 300a.

As shown in FIG. 28, FIG. 29, and FIG. 30, the sliding of the sliding housing 10 in the first direction (L) of the main housing 20 so as to be opened/closed will be described. As shown in FIG. 28, when the sliding housing 10 and the main housing 20 are engaged with each other while facing each other to open the sliding housing 10 respective to the main housing 20, the user slides the sliding housing 10 away from the main housing 20.

As shown in FIG. 28, when the sliding housing 10 and the main housing 20 are engaged with each other while facing each other, since the sliding housing 10 overlaps the main housing 20, one surface of the main housing 20 remains completely covered.

As shown in FIG. 29, when the sliding housing 10 is pushed along the first direction (L) of the main housing 20, the first fixing member 120 is released from the first locking part 311 and enters the first guide reset part 312, and the second fixing member 220 is released from the second locking part 321 and enters the third guide reset part 322.

Accordingly, as the sliding housing 10 slides while being turned around about the first and second fixing members 120 and 220, a first side area S1 and a lower area L1 of the main housing 20 are sequentially opened/closed. As shown in FIG. 30, when the sliding housing 10 protrudes from an upper side of the main housing 20 to be aligned parallel to the main housing 20, the first fixing member 120 and the second fixing member 220 are engaged with the first stopper groove 312a and the third stopper groove 322a, respectively, so as to be fixed so that the sliding housing 10 is opened.

An operation of the force supplying unit 130 when the sliding housing 10 is opened is described with reference to FIG. 27 and FIG. 29. As the sliding housing 10 slides, one part of the coil spring 130 coupled with the supporting protuberance 202 of one side of the guide member 300a and the other part of the coil spring 130 coupled with the supporting protuberance 202 of the other side of the guide member 300a, with reference to the fixing member 120, are compressed and extended, respectively. Therefore, as shown in FIG. 30, the coil spring 130 keeps the sliding housing 10 open.

To close the whole area of one surface of the main housing 20 by overlapping the sliding housing 10 on the main housing 20, the user slides the sliding housing 10 toward the main housing 20.

Because of this, as shown in FIG. 29, the first fixing member 120 is released from the first stopper groove 312a and simultaneously enters the first guide reset part 312, and the second fixing member 220 is released from the third stopper groove 322a and simultaneously enters the third guide reset part 322, so that the first side area S1 and the lower area L1 are sequentially opened/closed.

As shown in FIG. 28, the first fixing member 120 is engaged with the first locking part 311, and the second fixing member 220 is engaged with the second locking part 321 so that the sliding housing 10 simultaneously overlaps the main housing 20 so as to be closed.

Also, an operation of the force supplying means 130 when the sliding housing 10 is closed is now briefly described. As the sliding housing 10 slides, one part of the coil spring 130 coupled with the supporting protuberance 302 of one side of the guide member 300a and the other part of the coil spring 130 coupled with the supporting protuberance 202 of the other side of the guide member 300a, with respect to the fixing member 120, are compressed and extended, respectively. Therefore, the coil spring 130 keeps the sliding housing 10 closed.

As shown in FIG. 28, FIG. 31, and FIG. 32, the sliding of the sliding housing 10 in the second direction (L) of the main housing 20 so as to be opened/closed will be described below.

As shown in FIG. 31, when the sliding housing 10 is pushed in the second direction (L) of the main housing 20, the first fixing member 120 is released from the first locking part 311 and simultaneously enters the second guide reset part 313, and simultaneously, the second fixing member 220 is released from the second locking part 321 and simultaneously enters the fourth guide reset part 323. Accordingly, the second side area S2 and the lower area L1 of the main housing 20 are sequentially opened/closed. As shown in FIG. 32, the first fixing member 120 is engaged with the second stopper groove 313a disposed on one end of the second guide reset part 313, and the second fixing member 220 is engaged with the fourth stopper groove 323a disposed on one end of the fourth guide reset part 323, and the sliding housing simultaneously protrudes from an upper side of the main housing 20 parallel to the main housing 20 so as to be opened while facing the main housing 20.

An operation of the force supplying unit 130 when the sliding housing 10 is opened is now briefly described with reference to FIG. 28, FIG. 31, and FIG. 32. As the sliding housing 10 slides, one part of the coil spring 130 coupled with the supporting protuberance 202 of one side of the guide member 300a and the other part of the coil spring 130 coupled with the supporting protuberance 202 of the other side thereof, with reference to the fixing member 120, are compressed and extended, respectively. Therefore, the coil spring 130 keeps the sliding housing 10 open.

To close the whole area of one surface of the main housing 20 by overlapping the sliding housing 10 on the main housing 20, the user slides the sliding housing toward the main housing 20. Accordingly, as shown in FIG. 31, the first fixing member 120 is released from the second stopper groove 313a and simultaneously enters the second guide reset part 313, and the second fixing member 220 is released from the fourth stopper groove 323a and simultaneously enters the fourth guide reset part 323, so that the second side area S2 and the lower area L1 are sequentially opened/closed.

In this state, as shown in FIG. 28, the first fixing member 120 is engaged with the first locking part 311, the second fixing member 220 is engaged with the second locking part 321, and the sliding housing 10 simultaneously overlaps the main housing 20 so as to be closed.

Also, an operation of the force supplying unit 130 when the sliding housing 10 is closed is now briefly described. As the sliding housing 10 slides, one part of the coil spring 130 coupled with the supporting protuberance 302 of one side of the guide member 300a and the other part of the coil spring 130 coupled with the supporting protuberance 202 of the other side the guide member 300a, with respect to the fixing member 120, are compressed and extended, respectively. Therefore, the coil spring 130 keeps the sliding housing 10 closed.

Also, in a state of the sliding housing 10 protruding form an upper side of the main housing 20 so as to be aligned parallel to the main housing 20, the first guide member 300a is disposed on a surface of the main housing 20 where the sliding housing 10 and the main housing 20 face each other. The guide construction to guide the sliding movement of the sliding housing 10 is not shown so that it may be possible to secure the aesthetic appearance thereof.

As described above, a sliding apparatus of a sliding type portable terminal according to exemplary embodiments of the present invention includes a fixing member perpendicularly extending from one surface of the main housing in a state of a sliding housing facing the main housing, and includes a guide part to guide the sliding direction of the sliding housing at one surface of the sliding housing. Therefore, the sliding housing slides along the guide part about the fixing member, which may provide for a variety of sliding type portable terminals.

Also, the sliding housing sequentially opens one partial area and the other partial area of one surface of the main housing. When one partial area is opened, it sequentially closes the other partial area, which has been opened, so that the sliding housing is sequentially positioned at an upper part, a side of the upper part, and a side of the main housing. Therefore, the user can select the sliding direction of the sliding housing according to a desired function such as voice calling, writing email, or watching broadcasting, so that the user may conveniently use the terminal. Also, if an elastic member is used to supply a force to slide the sliding housing and also to maintain the stopped sliding housing, it may be possible to improve the structural stability of the portable terminal.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A sliding apparatus of a sliding type portable terminal, comprising:
a main housing comprising a fixing member; and
a sliding housing slidably coupled with the main housing, the sliding housing comprising a guide part,
wherein the guide part is engages with the fixing member to guide the sliding housing along a curved path on the main housing in a left direction and a right direction about a central axis of the fixing member.

2. The sliding apparatus of a sliding type portable terminal of claim 1, wherein:
the sliding housing slides along the right direction of the main housing to provide a first mode, and
the sliding housing slides along the left direction of the main housing to provide a second mode,
each of the first mode and the second mode comprising at least one of a phone mode, a digital multimedia broadcasting mode, a camera mode, and a game mode.

3. The sliding apparatus of a sliding type portable terminal of claim 2, wherein:
the fixing member comprises a guide protuberance perpendicularly extending from a surface of the main housing that faces the sliding housing, and
the guide part receives the guide protuberance and is arranged at a rear surface of the sliding housing that faces the main housing when the sliding housing is opened respective to the main housing.

4. The sliding apparatus of a sliding type portable terminal of claim 3, wherein the guide part comprises:
a locking part coupled with the fixing member to restrict movement of the sliding housing;
a first guide reset part provided at one side of the locking part, the first guide reset part comprising a curved path on the sliding housing in a seconddirection of the main housing so as to allow a first side area and a lower area of the main housing to be exposed when the sliding housing slides; and
a second guide reset part provided at another side of the locking part, the second guide reset part comprising a curved path on the sliding housing in a first direction of the main housing to allow a second side area and the lower area of the main housing to be opened when the sliding housing slides, and
wherein the fixing member which is disengaged with the locking part and guided so as to slide into the first guide reset part or the second guide reset part according to the first mode and the second mode of the portable terminal when the sliding housing slides.

5. The sliding apparatus of a sliding type portable terminal of claim 4, wherein:
the guide part extends toward a lower side of the sliding housing about the locking part,
a first stopper groove is included at one end of the first guide reset part, and
a second stopper groove is included at one end of the second guide reset part.

6. The sliding apparatus of a sliding type portable terminal of claim 5, wherein:
the sliding housing overlaps the main housing when the fixing member is located at the locking part;
the lower area and the first side area of one surface of the main housing are exposed when the fixing member slides along the first guide reset part;
the sliding housing is aligned at an upper side of the main housing parallel to the main housing so that the lower area of the main housing is exposed when the fixing member is positioned at the first stopper groove;
the lower area and the second side area of the main housing are exposed when the fixing member slides along the second guide reset part; and
the sliding housing is aligned at the upper side of the main housing parallel to the main housing so that the lower area of the main housing is exposed when the fixing member is located at the second stopper groove.

7. A sliding apparatus of a sliding type portable terminal comprising:
a main housing comprising a first fixing member and a second guide part; and
a sliding housing slidably coupled with the main housing, the sliding housing comprising a second fixing member and a first guide part,
wherein the first guide part is engaged with the first fixing member to guide the sliding housing along a curved path on the main housing in a left direction and a right direction about a central axis of the first fixing member, and
wherein the second guide part is engaged with the second fixing member to guide the sliding housing member along a curved path on the main housing in the left direction and the right direction about a central axis of the second fixing member.

8. The sliding apparatus of a sliding type portable terminal of claim 7, wherein:
the sliding housing slides along the right direction of the main housing to provide a first mode,
the sliding housing slides along the left direction of the main housing to provide a second mode, and
each of the first mode and the second mode comprises at least one of a phone mode, a digital multimedia broadcasting mode, a camera mode, and a game mode.

9. The sliding apparatus of a sliding type portable terminal of claim 7, wherein:
the first fixing member perpendicularly extends from a surface of the main housing that faces the sliding housing;
the second fixing member perpendicularly extends from a surface of the sliding housing that faces the main housing;
the first guide part is mounted on the main housing and is included at a rear surface of the sliding housing that faces the main housing, the first guide part being exposed on the surface of the sliding housing so that the first guide part engages with the first fixing member to guide a sliding movement of the sliding housing; and
the second guide part is mounted on the main housing and is included at a front surface of the main housing that faces the sliding housing, the second guide part being exposed on the surface of the main housing so that the second guide part engages with the second fixing member to guide a sliding movement of the sliding housing.

10. The sliding apparatus of a sliding type portable terminal of claim 9, wherein the first guide part comprises:
a first locking part to couple with the first fixing member to restrict a sliding movement of the sliding housing;
a first guide reset part provided at a side of the first locking part, the first guide reset part comprising a curved path in a second direction of the main housing to allow a first side area and a lower area of the main housing to be exposed when the sliding housing slides; and
a second guide reset part provided at another side of the first locking part, the second guide reset part comprising a curved path in a first direction of the main housing to allow a second side area and the lower area of the main housing to be exposed when the sliding housing slides, and
wherein the second guide part comprises:
a second locking part to couple with the second fixing member to restrict a sliding movement of the sliding housing;
a third guide reset part provided at one side of the second locking part, the third guide reset part guiding the second fixing member along a path provided in the second direction of the main housing when the first fixing member is guided to slide along the first guide reset part; and
a fourth guide reset part provided at another side of the second locking part, the fourth guide reset part guiding the second fixing member along a path provided in the first direction of the main housing when the first fixing member is guided along the second guide reset part.

11. The sliding apparatus of a sliding type portable terminal of claim 10, wherein:
the first guide part extends toward a lower side of the sliding housing about the first locking part;
a first stopper groove is included at one end of the first guide reset part;
the second guide part extends toward an upper side of the sliding housing about the second locking part;
a second stopper groove is included at one end of the second guide reset part;
a third stopper groove is included at one end of the third guide reset part; and
a fourth stopper groove is included at one end of the forth guide reset part.

12. The sliding apparatus of a sliding type portable terminal of claim 11 wherein:
the first fixing member is engaged with the first locking part and the second fixing member is engaged with the second locking part when the main housing faces the sliding housing;
the first fixing member slides along the first guide reset part, and the second fixing member simultaneously slides along the third guide reset part so that the lower area and the first side area of the main housing are sequentially opened or closed when the sliding housing slide along the first direction of the main housing;
the first fixing member is engaged with the first stopper groove, and the second fixing member is simultaneously engaged with the third stopper groove when the sliding housing is aligned in parallel to an upper side of the main housing;
the first fixing member slides along the second guide reset part, and the second fixing member simultaneously slides along the fourth guide reset part so that the lower area and the second side area of the main housing are sequentially opened or closed when the sliding housing slides in the second direction of the main housing; and
the first fixing member is engaged with the second stopper groove, and the second fixing member is simultaneously engaged with the fourth stopper groove when the sliding housing is aligned parallel to the upper side of the main housing.

13. A sliding apparatus of a sliding type portable terminal, comprising:
a main housing comprising a fixing member;
a sliding housing slidably coupled with the main housing and comprising a guide member, the guide member engaging with the fixing member to guide the sliding housing along a curved path on the main housing in a left direction and a right direction about a central axis of the fixing member; and
a force supplying unit to supply a force to slide the sliding housing on the main housing.

14. The sliding apparatus of a sliding type portable terminal of claim 13 wherein:
the portable terminal enters a first mode when the sliding housing slides along the right direction of the main housing,
the portable terminal enters a second mode when the sliding housing slides along the left direction of the main housing, and
each of the first mode and the second mode comprises at least one of a phone mode, a digital multimedia broadcasting mode, a camera mode, and a game mode.

15. The sliding apparatus of a sliding type portable terminal of claim 13, wherein:
the fixing member comprises a guide protuberance perpendicularly extending from one surface of the main housing that faces the sliding housing, and
the guide member is mounted on the sliding housing and comprises a guide part included at a rear surface of the sliding housing that faces the main housing, the guide part being exposed on the surface of the sliding housing, so as to be engaged with the fixing member to guide a sliding movement of the sliding housing.

16. The sliding apparatus of a sliding type portable terminal of claim 15, wherein the guide part comprises:
a locking part assembled with the first fixing member to restrict a sliding movement of the sliding housing;
a first guide reset part provided at a side of the locking part, the first guide reset part comprising a curved path on the sliding housing in a seconddirection of the main housing to allow a first side area and a lower area of the main housing to be exposed when the sliding housing slides;
a second guide reset part provided at another side of the locking part, the second guide reset part comprising a curved path on the sliding housing in a first direction of the main housing to allow a second side area and the lower area of the main housing to be exposed when the sliding housing slides, and
wherein the fixing member is engaged with the locking part and is simultaneously guided to slide along the first guide reset part and the second guide reset part when the sliding housing slides.

17. The sliding apparatus of a sliding type portable terminal of claim 16, wherein:
the guide part extends toward a lower side of the sliding housing about the locking part,
the first stopper groove is included at one end of the first guide reset part, and the second stopper groove is included at one end of the second guide reset part.

18. The sliding apparatus of a sliding type portable terminal of claim 17, wherein:
the sliding housing overlaps the main housing when the fixing member is located at the locking part;
the fixing member opens a lower area and the first side area of the main housing when the fixing member slides along the first guide reset part;
the fixing member exposes the lower area of the main housing when the fixing member is located at the first stopper groove;
the fixing member exposes the lower area and a second side area of the main housing when the fixing member slides along the second guide reset part; and
the fixing member exposes the lower area of the main housing when the fixing member is located at the second stopper groove.

19. The sliding apparatus of a sliding type portable terminal of claim 13, wherein the force supplying unit comprises:
a coil part, and
a coil spring having a pair of free ends that each extend away from the coil part, one free end being supported by the fixing member, and the other free end being supported by a supporting protuberance included in the guide member.

20. The sliding apparatus of a sliding type portable terminal of claim 13, wherein the force supplying unit comprises a push rod, a first end of the push rod being supported by the fixing member, and a second end of the push rod being supported by the supporting protuberance included in the guide member.

21. A sliding apparatus of a sliding type portable terminal, comprising:
a main housing comprising a first fixing member and a second guide member; and
a sliding housing slidably coupled with the main housing, the sliding housing comprising a second fixing member and a first guide member;
wherein the first guide member engages with the first fixing member to guide the sliding housing along a curved path on the main housing in a left direction and a right direction about a central axis of the first fixing member, and
wherein the second guide member engages with the second fixing member to guide the sliding housing member along a curved path on the main housing in the left direction and the right direction about a central axis of the second fixing member.

22. The sliding apparatus of a sliding type portable terminal of claim 21, wherein:
the sliding housing slides along the right direction of the main housing to provide a first mode,
the sliding housing slides along the left direction of the main housing to provide a second mode, and
each of the first mode and the second mode may comprise at least one of a phone mode, a digital multimedia broadcasting mode, a camera mode, and a game mode.

23. The sliding apparatus of a sliding type portable terminal of claim 21, wherein:
the first fixing member perpendicularly extends from a surface of the main housing that faces the sliding housing;
the second fixing member perpendicularly extends from a surface of the sliding housing that faces the main housing;
the first guide member is mounted on the sliding housing and is included at a rear surface of the sliding housing that faces the main housing, the first guide member being exposed on the surface of the sliding housing so that the first guide member engages with the first fixing member to guide a sliding movement of the sliding housing; and
the second guide member is mounted on the main housing and included at a front surface of the main housing that faces the sliding housing, the second guide member being exposed on the surface of the main housing so that the second guide member engages with the second fixing member to guide a sliding movement of the sliding housing.

24. The sliding apparatus of a sliding type portable terminal of claim 23, wherein the first guide part comprises:
a first locking part to couple with the first fixing member to restrict a sliding movement of the sliding housing;
a first guide reset part provided at one side of the first locking part, the first guide reset part comprising a curved path in a second direction of the main housing to allow a first side area and a lower area of the main housing to be exposed when the sliding housing slides; and
a second guide reset part provided at second side of the first locking part, the second guide reset part comprising a curved path in a first direction of the main housing to allow a second side area and the lower area of the main housing to be opened when the sliding housing slides, and
wherein the second guide part comprises:
a second locking part to couple with the second fixing member to restrict a sliding movement of the sliding housing;
a third guide reset part provided at one side of the second locking part, the third guide reset part guiding the second fixing member along a path provided in the second direction of the main housing when the first fixing member is guided along the first guide reset part; and
a fourth guide reset part provided at another side of the second locking part, the fourth guide reset part guiding the second fixing member along a path provided in the first direction of the main housing when the first fixing member is guided along the second guide reset part.

25. The sliding apparatus of a sliding type portable terminal of claim 24, wherein:
the first guide part extends toward a lower side of the sliding housing about a first locking part;
a first stopper groove is included at one end of the first guide reset part;
the second guide part extends toward an upper side of the sliding housing about a second locking part;
a second stopper groove is included at one end of the second guide reset part;
a third stopper groove is included at one end of the third guide reset part; and
a fourth stopper groove is included at one end of the forth guide reset part.

26. The sliding apparatus of a sliding type portable terminal of claim 25, wherein:
the first fixing member is engaged with the first locking part and the second fixing member is engaged with the second locking part when the main housing faces the sliding housing;
the first fixing member slides along the first guide reset part and the second fixing member simultaneously slides along the third guide reset part so that the lower area and the first side area of the main housing are sequentially opened or closed when the sliding housing slides along the first direction of the main housing;
the first fixing member is engaged with the first stopper groove and the second fixing member is simultaneously engaged with the third stopper groove when the sliding housing is aligned in parallel at an upper side of the main housing;
the first fixing member slides along the second guide reset part and the second fixing member simultaneously slides along the fourth guide reset part so that the lower area and the second side area of the main housing are sequentially opened or closed when the sliding housing slides in the second direction of the main housing; and
the first fixing member is engaged with the second stopper groove and the second fixing member is simultaneously engaged with the forth stopper groove when the sliding housing is aligned at the upper side of the main housing parallel to the main housing.

27. The sliding apparatus of a sliding type portable terminal of claim 21, further comprising:
a force supply unit having one end supported by the first fixing member and another end supported by the first guide member to supply a driving force to slide the sliding housing on the main housing.

28. The sliding apparatus of a sliding type portable terminal of claim 27, wherein the force supplying unit comprises:
a coil part, and
a coil spring having a pair of free ends that each extend away from the coil part,
wherein one free end is supported by the fixing member, and the other free end is supported by a supporting protuberance included in the first guide member.

29. The sliding apparatus of a sliding type portable terminal of claim 27, wherein the force supply unit includes a push rod, in which a first end of the push rod is supported by the fixing member, and a second end of the push rod is supported by a supporting protuberance included in the guide member.
